(19) United States
(12) Patent Application Publication
(10) Pub. No.: US 2024/0239266 A1
(43) Pub. Date: Jul. 18, 2024

(54) VEHICULAR EXTERIOR MIRROR WITH POWERFOLD ACTUATOR

(71) Applicant: Magna Mirrors of America, Inc., Holland, MI (US)

(72) Inventors: Matthew V. Steffes, Grand Rapids, MI (US); Darryl P. De Wind, West Olive, MI (US); Kenneth C. Peterson, Ada, MI (US); Justin E. Sobecki, Rockford, MI (US)

(21) Appl. No.: 18/408,889

(22) Filed: Jan. 10, 2024

Related U.S. Application Data
(60) Provisional application No. 63/479,764, filed on Jan. 13, 2023.

(51) Int. Cl. B60R 1/074; B60R 1/12

(52) U.S. Cl. CPC B60R 1/074; B60R 1/1207

(57) ABSTRACT

A vehicular exterior rearview mirror assembly includes a mirror head movable relative to a mounting base between an extended position and a folded position. An actuator is electrically operable to move the mirror head between the folded and extended positions. A pivot tube extends from the mounting base and through a base portion of the actuator. The pivot tube includes a tapered portion at least partially received at a channel of the mounting base. An inner surface of the channel includes a shape that corresponds to a shape of an outer surface of the tapered portion. A biasing element disposed between a housing of the actuator and an upper end of the pivot tube biases the tapered portion toward engagement with the inner surface of the mounting base along the channel.

### CROSS REFERENCE TO RELATED APPLICATION

The present application claims the filing benefits of U.S. provisional application Ser. No. 63/479,764, filed Jan. 13, 2023, which is hereby incorporated herein by reference in its entirety.

### FIELD OF THE INVENTION

The present invention relates generally to the field of exterior rearview mirror assemblies for vehicles and, more particularly, to the field of powerfold exterior rearview mirror assemblies.

### BACKGROUND OF THE INVENTION

It is known to provide a vehicular exterior rearview mirror assembly that includes a foldable mirror assembly, such as a powerfold mirror where the mirror head is pivotable via an actuator between a drive or use position and a folded or park position.

### SUMMARY OF THE INVENTION

A rearview mirror assembly (such as an exterior mirror assembly mounted at a side of an equipped vehicle) includes a mirror head that includes a mirror reflective element, and a mounting base configured for attachment at the side of the vehicle. The mirror head is movable relative to the mounting base between at least an extended position, where the mirror head is extended outward from the side of the vehicle so that the mirror reflective element is positioned to provide a rearward view at the side of the vehicle to a driver of the vehicle, and a folded position, where the mirror head is moved inward from the extended position toward the side of the vehicle. A powerfold actuator is electrically operable to move the mirror head relative to the mounting base between the folded position and the extended position. The powerfold actuator includes a base portion that attaches at the mounting base and a pivot tube that extends from the mounting base and through the base portion. The pivot tube extends through a detent assembly of the powerfold actuator and a housing of the powerfold actuator. The mirror head is attached at the housing of the powerfold actuator. The mirror head and the housing of the powerfold actuator, when the powerfold actuator is electrically operated, move together and in tandem about a longitudinal axis of the pivot tube of the powerfold actuator. The powerfold actuator includes a biasing element disposed between the housing of the powerfold actuator and an upper end of the pivot tube, and the biasing element releasably retains the powerfold actuator in at least one detent state of the powerfold actuator. The pivot tube includes a lower end that is opposite the upper end of the pivot tube and that is disposed along a channel of the mounting base. The lower end of the pivot tube includes a conical portion having an outer conical-shaped surface that engages a corresponding conical portion of the channel of the mounting base. The biasing element disposed between the housing of the powerfold actuator and the upper end of the pivot tube biases the pivot tube away from the mounting base along the longitudinal axis and the conical portion of the pivot tube is biased into engagement with the corresponding conical portion of the channel of the mounting base.

These and other objects, advantages, purposes and features of the present invention will become apparent upon review of the following specification in conjunction with the drawings.

### BRIEF DESCRIPTION OF THE DRAWINGS

FIG. 1 is a view of an exterior rearview mirror assembly disposed at the side of a vehicle;

FIG. 2 is a view of the exterior rearview mirror assembly in an extended or use position;

FIG. 3 is a view of the exterior rearview mirror assembly pivoted from the extended position to a folded or non-use position;

FIG. 4 is a sectional view of the exterior rearview mirror assembly, showing the actuator that is electrically operable to pivot the mirror head relative to a mounting base at the side of the vehicle;

FIG. 5 is a sectional view of a portion of the actuator assembly and mounting base;

FIG. 6 is a perspective view of a pivot tube of the actuator assembly with a tapered or conical or frustoconical portion at an end of the pivot tube;

FIGS. 7 and 8 are views of the mounting base with guide ribs disposed along a channel of the mounting base that receives the pivot tube;

FIGS. 9A-9C depict different configurations of the interface between the channel of the mounting base and the pivot tube;

FIG. 10 depicts a manufacturing process for forming the pivot tube;

FIG. 11 is a sectional view of a portion of the actuator assembly and mounting base, where the actuator assembly includes a pivot washer between the biasing element and the retainer;

FIG. 12 is an exploded view of the mirror assembly with the pivot washer;

FIG. 13 is a sectional view of a portion of the actuator assembly and mounting base, where the mirror head bracket includes a drafted or tapered interference rib engaging a flat outer circumferential surface of the pivot washer;

FIG. 14 is an enlarged view of the pivot washer of FIG. 13;

FIGS. 15A-15C depict a shift of the pivot washer relative to the drafted interference rib when the mirror head is manually pivoted between the extended and folded positions;

FIG. 16 is a perspective view of the pivot washer of FIG. 13;

FIGS. 17 and 18 are sectional views of a portion of the actuator assembly and mounting base, where a zero draft insert is disposed between the interference rib and the pivot washer;

FIG. 19 is a perspective view of the zero draft insert;

FIG. 20 is an exploded view of the pivot assembly with the zero draft insert;

FIGS. 21A and 21B are perspective views of a zero draft insert with flexible barbs extending from an outer surface of the insert and drainage holes formed through the insert;

FIGS. 22A and 22B are perspective views of a zero draft insert with a tapered edge formed on the outer surface for easier assembly;

FIG. 23 is a sectional view of a portion of the actuator assembly with the zero draft insert of FIGS. 22A and 22B;

FIG. 24 is a perspective view of a spring loaded touchpad;

FIG. 25 is a perspective view of the base, with detent surfaces configured to engage the spring loaded touchpad of FIG. 24;

FIG. 26 is a perspective view of a toggle touchpad assembly;

FIG. 27 is a sectional view of a portion of the actuator assembly with the toggle touchpad of FIG. 26 engaging a detent surface and a toggle bumper of the base to secure the mirror head in a detent position;

FIGS. 28 and 29 are plan views of the base, showing radial positions of the detent surfaces and toggle bumpers;

FIG. 30 is an enlarged view of a detent surface and toggle bumper at the base;

FIG. 31 is an enlarged view of the toggle touchpad and base when the mirror head is in a non-detent position;

FIG. 32 is an enlarged view of the toggle touchpad and base when the mirror head is in a detent position;

FIG. 33 is a perspective view of the actuator assembly with a biasing element that resists movement of the actuator as the actuator pivots toward a travel stop;

FIG. 34 is a sectional view of the actuator assembly of FIG. 33;

FIG. 35 is a diagram that depicts the torque resistance of a typical spring plunger as the actuator pivots toward the travel stop;

FIG. 36 is a diagram that depicts example dimensions of the biasing element of FIG. 33;

FIG. 37 is a diagram that compares the travel time and current draw of the actuator with the biasing element of FIG. 33 to the actuator without the biasing element;

FIG. 38 is a plan view of a vehicle equipped with an exterior rearview mirror assembly having a mirror reflective element with a first portion providing a first field of view and a second portion providing a different second field of view;

FIG. 39 is a perspective view of the mirror assembly of FIG. 38;

FIGS. 40 and 41 are views of the mirror reflective element, where the first and second portions are part of a singular mirror reflective element and separated by a bend point of the mirror reflective element;

FIGS. 42 and 43 are views of the mirror reflective element, where the first and second portions are separate mirror reflective elements that are separated by a gap;

FIGS. 44-47 are views of a light module disposed at the mirror assembly;

FIG. 48 is a perspective view of the vehicle, depicting an example illumination viewing distance for light emitted by the light module; and

FIGS. 49 and 50 are views comparing light beam propagation of the light module having a total internal reflection lens and a light module having a traditional reflector.

### DESCRIPTION OF THE PREFERRED EMBODIMENTS

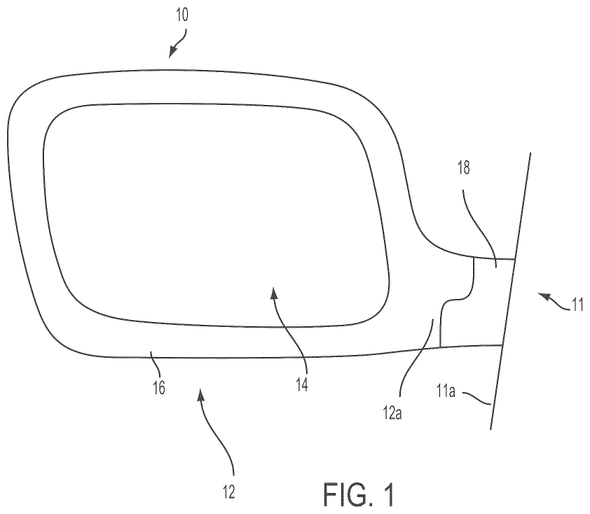

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIG. 1). The mirror head portion 12 includes a mounting portion 12a that is pivotally or movably mounted to a mounting arm or base or portion 18. The mirror assembly 10 comprises a powerfold mirror (where the mirror head portion may be pivoted via an actuator assembly or adjustment device), and may comprise a breakaway mirror (where the mirror head portion may be manually pivoted about the mounting arm or base). The mounting arm or base 18 of mirror assembly 10 is mounted at the side 11a of a host or subject vehicle 11 equipped with the mirror assembly 10, with the reflective element 14 providing a rearward field of view along the respective side of the vehicle to the driver of the vehicle, as discussed below.

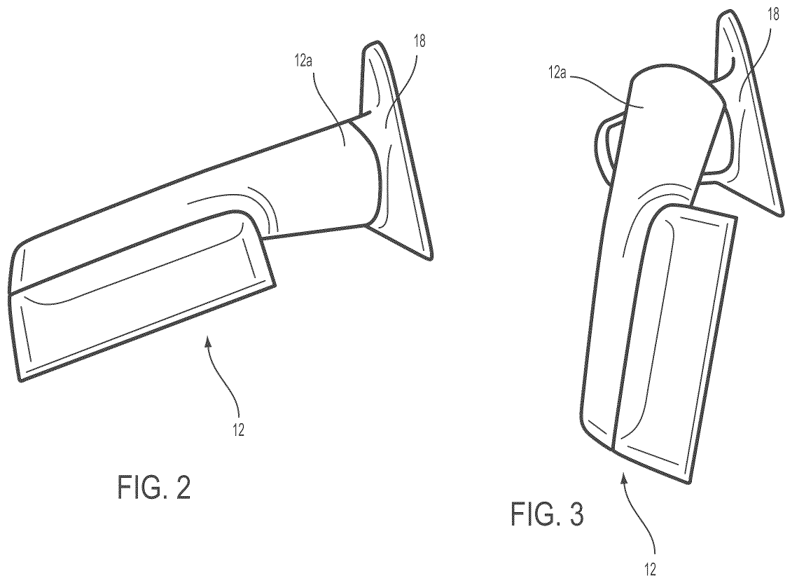

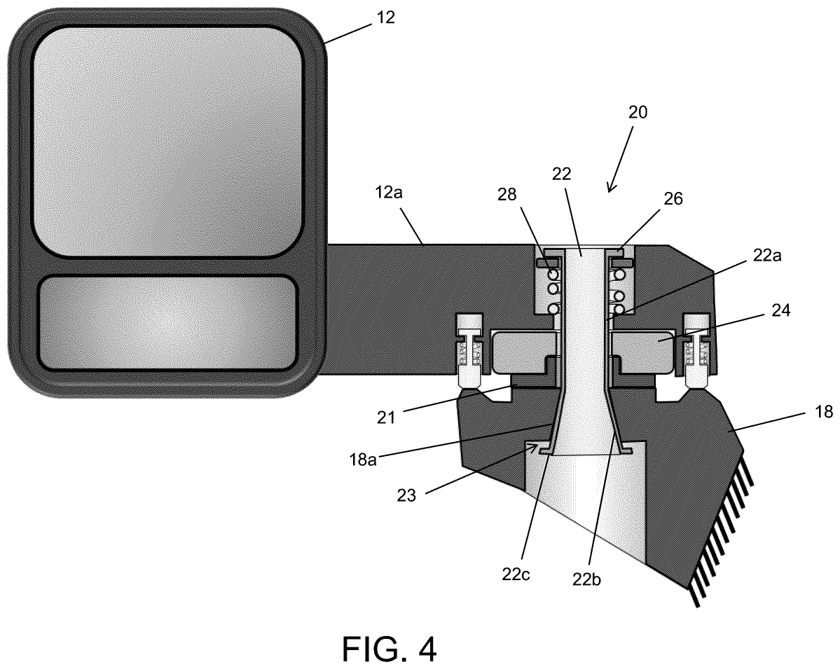

The powerfold mirror assembly 10 includes an actuator 20 (FIG. 4) that is operable to pivot the mirror head 12 (comprising the mirror casing 16 and reflective element 14) relative to the mounting arm or base 18. The actuator 20 operates, such as responsive to a user input, to pivot the mirror head 12 between a plurality of detent positions, including a use or drive position (FIG. 2) and a folded or park position (FIG. 3). The mirror head 12 is also pivotable manually to either the use or folded position. The actuator 20 may pivot the mirror head 12 between the drive position and the folded position responsive to the user input, or the actuator 20 may pivot the mirror head 12 automatically, such as upon completion of performance of a parking maneuver of the vehicle 11 or upon locking or unlocking of the doors of the vehicle 11.

When in the use or drive position, the mirror head 12 is extended from the side 11a of the vehicle 11 so as to provide the rearward field of view along the side 11a of the vehicle 11 to the driver of the vehicle 11. When in the folded or park position, the mirror head 12 is folded or pivoted or rotated from the extended position toward the side 11a of the vehicle 11, such that the mirror reflective element 14 maybe facing the side 11a of the vehicle 11 and does not provide the rearward field of view along the side 11a of the vehicle 11. Optionally, the mirror head 12 may also be pivoted to a fully forward position, where the mirror head 12 is folded or pivoted or rotated away from the folded position and beyond the use position, such that the mirror reflective element 14 may face sideward or forward away from the vehicle 11. The mirror head 12 may pivot toward the fully forward position manually, such as upon contact or a collision with an object. A seal may be disposed along the interface between the mounting portion 12a of the mirror head 12 and the mounting arm or base 18, such as to reduce noise or damage from vibration of the mirror head 12 relative to the mounting base 18 and/or to preclude moisture or debris from entering the mirror head 12 or mounting base 18.

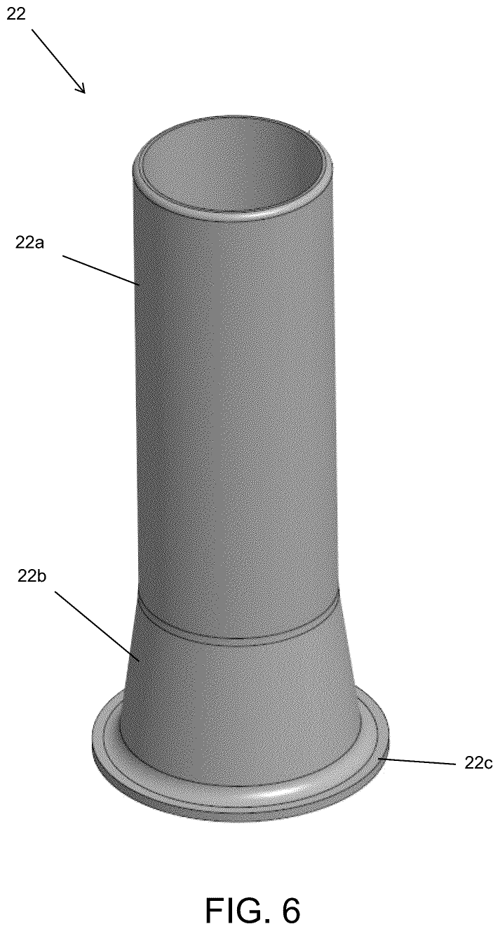

As shown in FIGS. 4-6, the mirror actuator 20 includes a pivot assembly that has a base post construction that is fixedly disposed at or attached at the mounting base 18 and that has a pivot tube or post 22 and a base 21 integrated together (or that has a separate base and pivot post joined together), with the pivot post 22 providing or defining a pivot axis for the mirror head 12 when the mirror head 12 is pivoted relative to the side of the vehicle 11 between at least the folded position, the use position, and the fully forward position. The post 22 extends from the mounting base 18 and extends through a detent assembly 24 of the actuator 20. A rotatable portion of the actuator 20 (e.g., an upper and/or lower housing or an output gear of the actuator) is pivotally fixed relative to the mirror head 12 so that, as the rotatable portion pivots about the pivot post 22, the mirror head 12 pivots about the pivot post 22 relative to the mounting base 18. The detent assembly 24 enables axial movement of the actuator 20 and mirror head 12 along the pivot post 22 as the mirror head 12 pivots about the pivot post 22 between the detent positions. For example, as the mirror head 12 is moved between the folded and use positions, the mirror head 12 and mounting portion 12a may separate from or lift relative to the mounting base 18 to reduce pressure on the seal disposed therebetween.

A retainer 26 is rigidly fastened to the post 22 or integrally formed as a flared end of the post 22, such that the retainer 26, post 22, and base 21 are effectively a single member or element and provide axial and rotational ground reference for all motions and forces. A spring or biasing element 28 is disposed between the retainer 26 and an upper surface of the actuator 20 (e.g., an upper surface of the detent assembly or housing of the actuator) and urges or biases the detent assembly 24 into engagement. The actuator 20 may utilize aspects of the actuators described in U.S. Pat. Nos. 7,887,202; 9,487,142; 11,396,264 and/or 9,067,541, and/or U.S. Publication Nos. US-2020-0223364; US-2021-0261053 and/or US-2022-0126751, and/or International Publication No. WO 2019/035078, which are all hereby incorporated herein by reference in their entireties.

The post 22 includes a first or cylindrical portion 22a that protrudes from the mounting base 18 and that defines the pivot axis for the mirror assembly along a longitudinal axis of the cylindrical portion 22a. The retainer 26 is disposed along the first portion 22a of the post 22, such as at a first end or upper end of the pivot post 22 opposite the mounting base 18. A second or conical or frustoconical or tapered portion 22b of the post 22 extends from an end of the cylindrical portion 22a opposite the upper end and extends into the mounting base 18 and engages the mounting base 18 to secure the pivot post 22 and mirror head 12 relative to the mounting base 18. Thus, a second end or lower end of the pivot post 22 opposite the upper end is disposed within the mounting base 18. The conical portion 22b of the post 22 extends from the lower end and the cylindrical portion 22a extends between the conical portion 22b and the upper end.

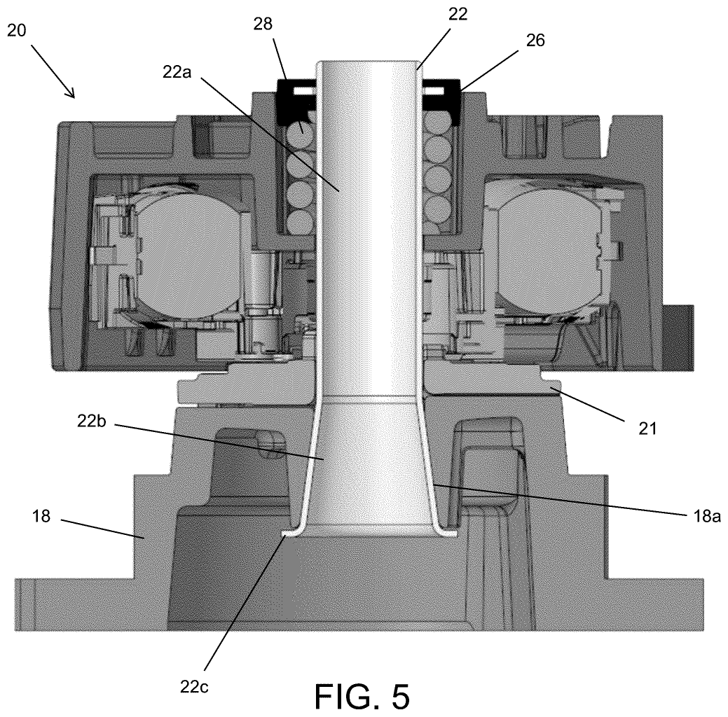

In the illustrated example, the mounting base 18 includes a conical or frustoconical or tapered channel 18a that corresponds to the conical portion 22b of the post 22. The biasing element 28 urges the conical portion 22b into engagement with the channel 18a to align the longitudinal axis of the post 22 with the longitudinal axis of the channel 18a and secure the mirror head 12 to the mounting base 18. That is, the biasing element 28 applies a separating force between the upper surface of the actuator and the retainer 26 to urge the post 22 away from the mounting base 18 (e.g., to pull the post 22 upward in FIG. 5), which causes the conical portion 22b to engage the channel 18a. The outward tapered profile of the conical portion 22b and the corresponding tapered profile of the channel 18a resists the biasing force of the biasing element 28 and locates the post 22 relative to the mounting base 18.

The conical portion 22b extends from an end of the first portion 22a opposite the retainer 26. For example, when the post 22 is disposed at the mounting base 18, the conical portion 22b may extend from the base 21 at an outer surface of the mounting base 18 and into the mounting base 18 along the channel 18a, with the conical portion 22b terminating within the mounting base 18 at a second end of the post 22 opposite the retainer 26. Optionally, the conical portion 22b may begin exterior the mounting base 18 or at a point along the channel 18a, such that a part of the cylindrical portion of the post 22 extends along the channel 18a.

A flange 22c extends radially outward from the conical portion 22b at the second end of the pivot post 22. When the pivot post 22 is disposed at the mounting base 18 and pulled into position via the biasing element 28, the flange 22c may be spaced from the mounting base 18 at the edge of the channel 18a, such as to account for tolerance differences between the mounting base 18 and pivot post 22 and allow for full contact between the conical portion 22b and the surface of the channel 18a. For example, FIG. 4 depicts a gap 23 between the flange 22c and the mounting base 18. The flange 22c may provide a datum point and/or grasping portion during the formation process of the pivot tube 22 and the flange 22c may provide snag-free wire routing for electrical connection between the actuator 20 and a wire harness of the vehicle along the hollow pivot tube 22.

The conical portion 22b may have any suitable taper angle relative to the cylindrical portion 22a. For example, the conical portion 22b may extend at an angle of 5 degrees, or 15 degrees, or 25 degrees, or 45 degrees or more relative to the cylindrical portion 22a. Furthermore, the conical portion 22b may have a constant taper or a progressive taper, such that the taper angle of the conical portion 22b increases as the post 22 extends along the channel 18a. A shape or curvature or profile of the interior surface of the mounting base 18 along the channel 18a may correspond to the shape or curvature or profile of the exterior surface of the conical portion 22b.

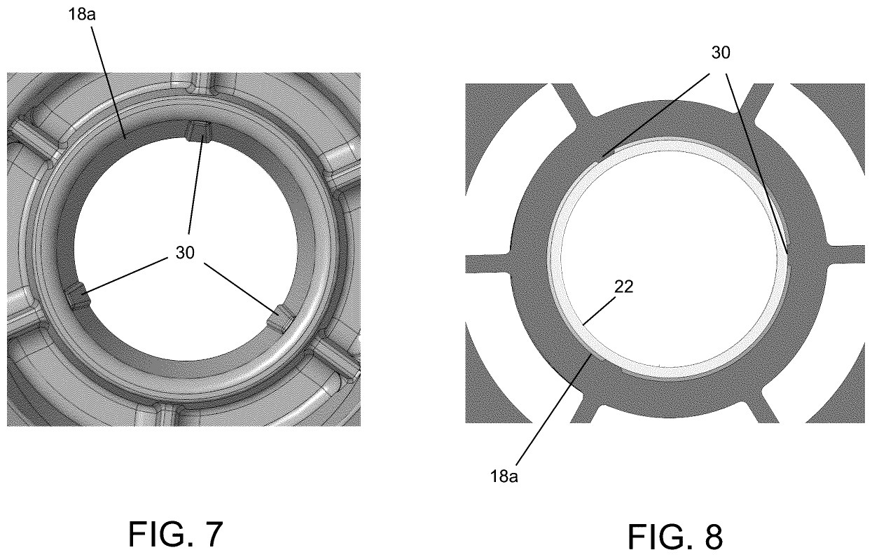

As shown in FIGS. 7 and 8, offset contact features or guide ribs 30 may extend radially inward from the inner surface of the mounting base 18 along the channel 18a to engage the conical portion 22b of the post 22. The guide ribs 30 are integrated into the mounting base 18 and provide a more easily tunable feature. Thus, the guide ribs 30, when the conical portion 22b of the post 22 engage the guide ribs 30, align the axes of the post 22 and mounting base channel 18a. The guide ribs 30 are uniformly spaced about the circumference of the channel 18a. In the illustrated example, three guide ribs 30 are disposed along the channel 18a, but four or five or more guide ribs 30 may be included.

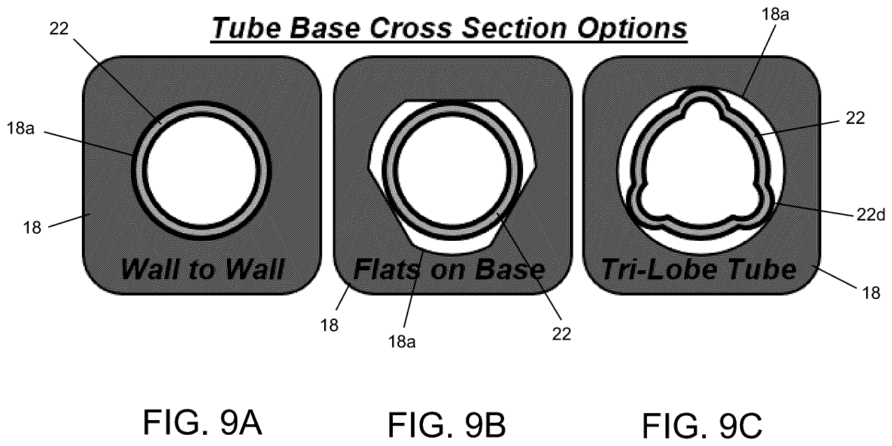

Other tube-to-base constraint methods may be employed. For example, the outer diameter of the outer surface of the pivot post 22 may correspond to an inner diameter of the cylindrical or conical channel 18a of the mounting base 18 to provide a wall to wall interface (FIG. 9A). Optionally, the surface of the channel 18a of the mounting base 18 may include one or more flat portions that engage the conical or cylindrical portion of the pivot post 22 to provide a flats on base interface (FIG. 9B). In another example, the pivot post 22 may include a multi-lobe tube (e.g., a tri-lobe tube), where protuberances or nodes 22d extend radially from a cylindrical or conical outer wall of the pivot tube 22 to engage a cylindrical or conical inner wall of the channel 18a of the mounting base 18, such as to provide a tri-lobe tube interface (FIG. 9C).

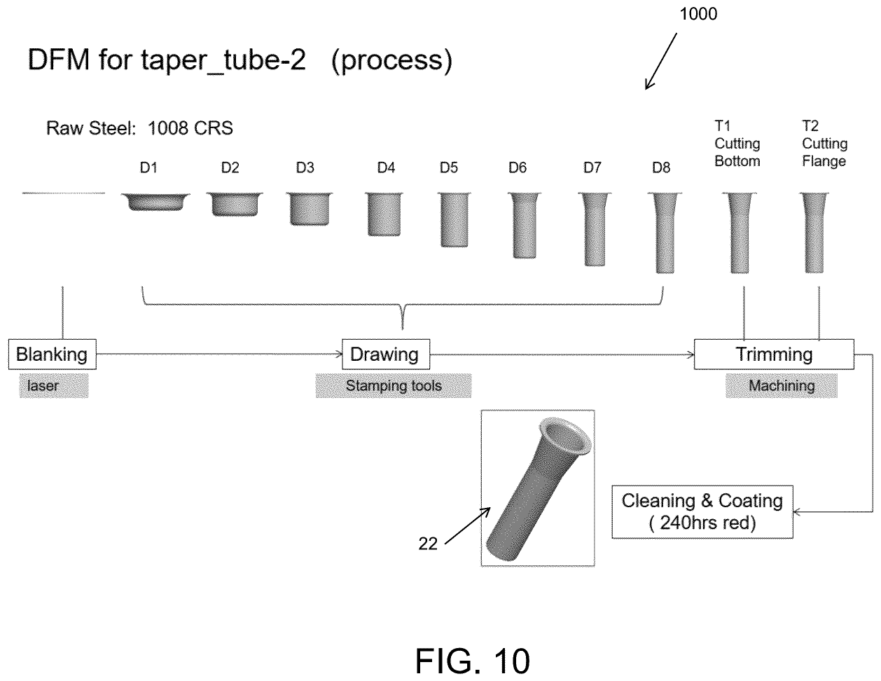

FIG. 10 depicts a manufacturing process for forming the pivot tube 22 with the conical portion 22b and flange 22c. As shown, the process 1000 may include drawing steel for the tube through eight (or any suitable number) of dies to achieve the length of the pivot tube 22 and taper of the conical portion. The process 1000 further includes cutting the bottom end (i.e., the end at the flange 22c) and cutting the flange 22c.

Thus, the actuator 20 includes a tapered pivot tube 22 that uses the spring load from the biasing element 28 (e.g., the spring load may be 100 N, 500 N, 1,000 N, 1,300 N or more) to pull and/or lock the post 22 to the mounting base 18, rigidly aligning the tube with the base pivot axis. This locks the pivot tube 22 to the base 18 without increasing the cost or number of parts, without relying on tight tolerances, and without damaging the tube during installation. A small gap 23 (determined by the tolerance stack) separates the bottom of the channel or pivot hole 18a of the base 18 and the flange 22c of the tube 22 to allow for up to 100 percent contact at the conical interface. Moreover, the conical portion 22b of the pivot tube 22 provides a funnel-like feature for easier wire harness insertion along the pivot tube.

Advantages of the pivot tube 22 with conical portion 22b may include improved stable constraints from vertical vibration inputs as the vehicle travels along the road. That is, the improved engagement of the pivot post and mounting base reduces the effects of road vibrations on the mirror assembly. Furthermore, the tube locks to the base, provides a tall contact area, is easy to manufacture and assemble, provides for easier routing of electrical wires, provides tolerance advantages, and does not require any additional parts.

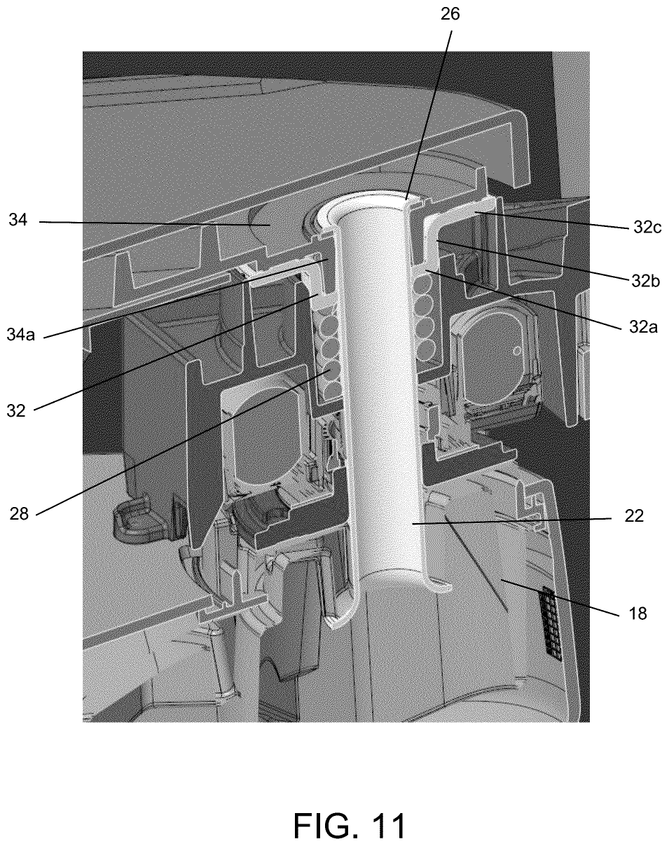

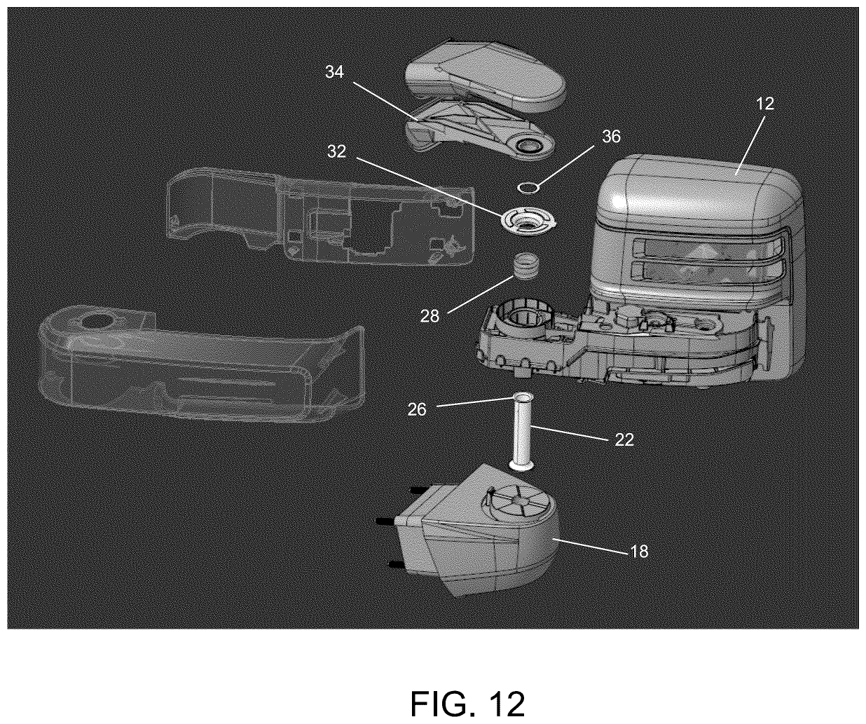

Referring to FIGS. 11 and 12, the actuator 20 may include a pivot washer 32 between the retainer 26 and the biasing element 28. Furthermore, an upper actuator housing or bracket element 34 may include a stack or flange or bushing portion 34a between the pivot washer 32 and the retainer 26. A washer 36 (e.g., a TEFLON™ washer) may be disposed between the retainer 26 and an upper surface of the upper housing bracket 34. Thus, the upper base features (i.e., the pivot washer 32 and the upper housing bracket 34) reduce strain on the pivot tube 22 and improve stability of the actuator 20 and mirror assembly. The pivot tube 22 may be lengthened to accommodate the pivot washer 32 and bracket flange 34a between the retainer 26 and the biasing element 28. Optionally, the upper bracket element 34 may be designed without a second rivet tube or bushing, which only adds the upper bracket element 34 and base cover to the standard single tube riveting process.

In the illustrated example, the pivot washer 32 includes a first flange portion 32a disposed radially about the pivot tube 22 and that engages the biasing element 28. A cylindrical portion 32b extends along the pivot tube 22 from the first flange portion 32a and toward the retainer 26, with a second flange portion 32c extending radially from an end of the cylindrical portion 32b opposite the first flange portion 32a. The second flange portion 32c extends along and below the upper actuator bracket 34 and engages the upper actuator bracket 34 to distribute force from the biasing element 28 to the upper bracket 34. Further, the flange portion 34a of the upper bracket 34 extends along the pivot tube 22 between the retainer 26 and the first flange portion 32a of the pivot washer 32 and radially inboard of the cylindrical portion 32b of the pivot washer 32 to further reduce strain on the pivot tube 32. The flange portion 34a of the upper bracket 34 engages a surface of the first flange portion 32a of the pivot washer 32 opposite the surface that engages the biasing element 28.

Thus, to reduce the part count and assembly process complexity, one of two rivet tubes present in the mirror assembly upper base may be removed. The upper base is assembled directly on top of the pivot washer in the rivet tube stack, and riveted together with just a single rivet tube. The assembly meets or exceeds vibration performance requirements. Benefits of eliminating the inner tube include a reduced part count (which includes the rivet tube and upper base bushing) and a reduced assembly process complexity (e.g., only one riveting process). Thus, the upper base allows for a reduced pivot spring load on the powerfold actuator and an increased rivet tube inner diameter allows for easier wire harness routing.

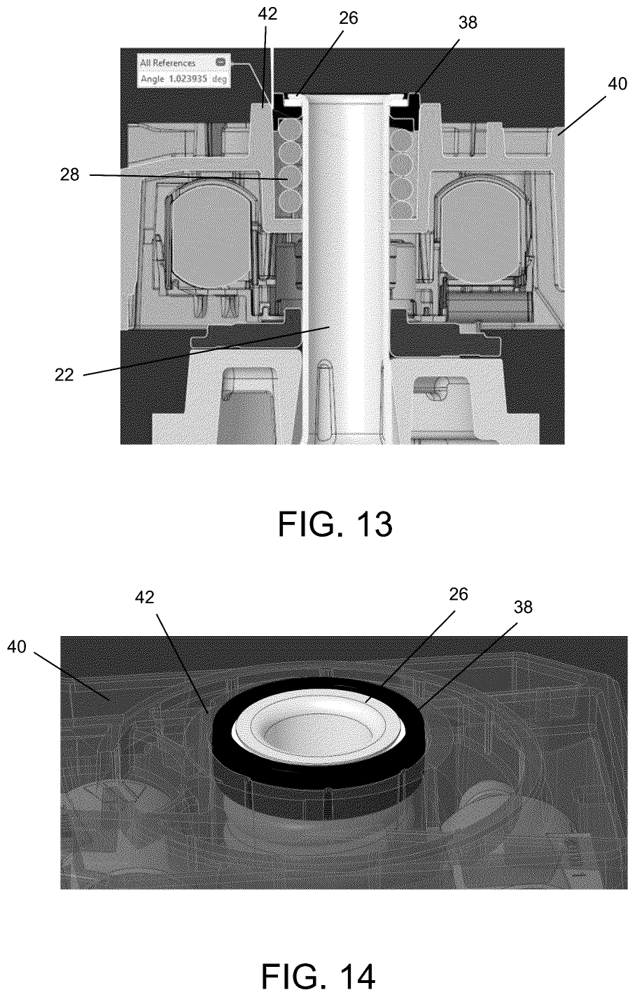

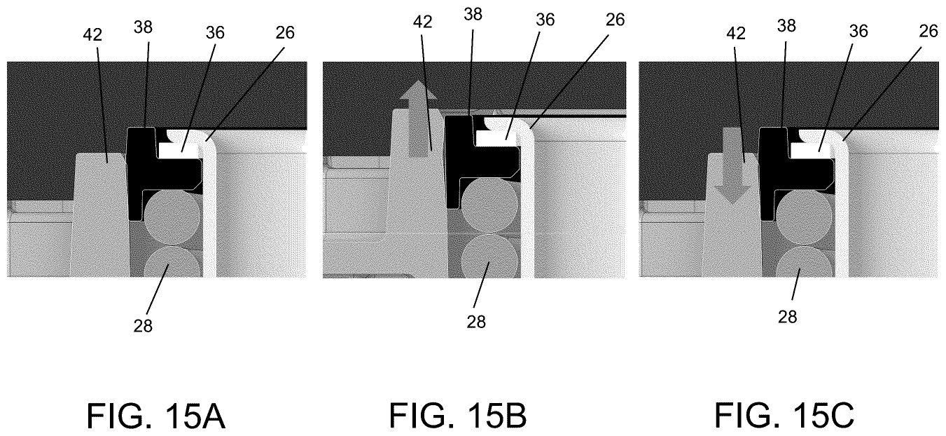

Referring now to FIGS. 13-16, a pivot washer 38 with a substantially flat circumferential outer surface may be disposed between the retainer 26 and the biasing element 28 (with the washer 36 optionally disposed between the pivot washer 38 and the biasing element 28). The pivot washer 38 may be constrained to the actuator bracket or housing 40 by one or more drafted or tapered interference ribs 42 formed in the housing 40. That is, the engagement surface between the rib 42 and the flat circumferential side surface of the pivot washer 38 may have a tapered upper edge, such as shown in FIGS. 15A-15C.

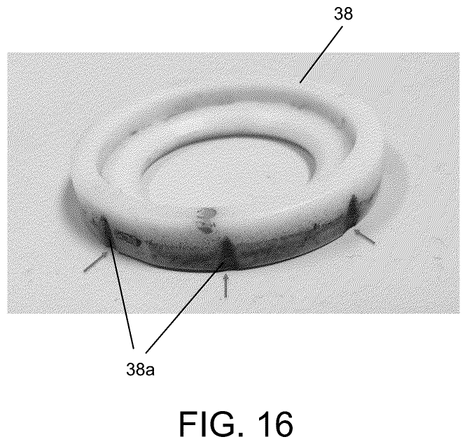

When the mirror head 12 is folded manually relative to the mounting base 18 between the extended and folded positions (FIG. 15A), the mirror head and/or arm is lifted upward by disengaging the detent features and the housing 40 moves along the pivot tube 22 (FIG. 15B). When the mirror head and housing 40 lift upward, the pivot washer 38 is forced further into the drafted interference ribs 42. That is, because the movement of the mirror head and housing 40 along the pivot tube 22 is opposite the biasing direction of the biasing element 28, the pivot washer 38 may shift along the surface of the interference ribs 42 along the housing 40. The pivot washer 38 may include indentations 38a extending radially into the outer surface of the pivot washer 38 to accommodate this movement between the washer and bracket interface (FIG. 16). Thus, when the detent features re-engage, the actuator housing 40 drops back down (FIG. 15C) and leaves a larger gap where the pivot washer 38 interacts with the interference ribs 42. In other words, the nominal position of the pivot washer 38 (and thus the retainer 26 and pivot tube 22) relative to the housing 40 and mirror head 12 shifts, which may reduce the engagement surface between the pivot washer 38 and the housing 40. The reduced engagement may affect vibration performance and durability of the assembly. Thus, the folding pivot may be a weak point of the folding mirror assembly with regards to vibration and durability, and the pivot washer and mirror head/arm bracket interface may be a large contributor to this weakness.

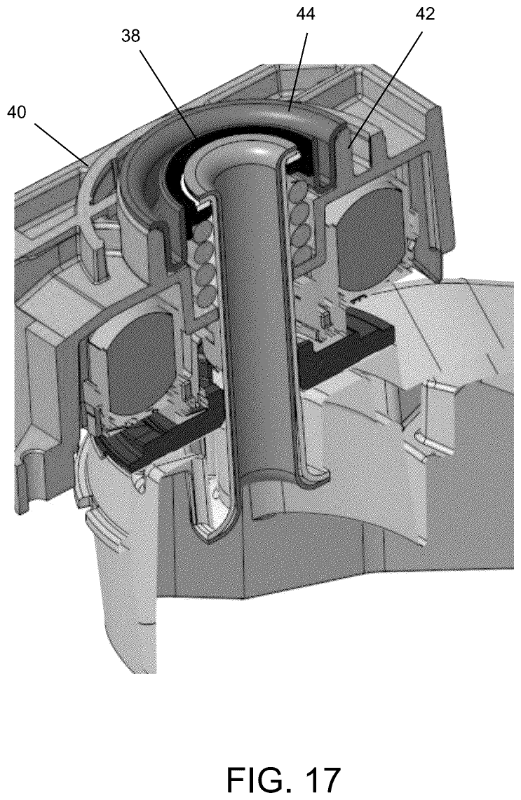

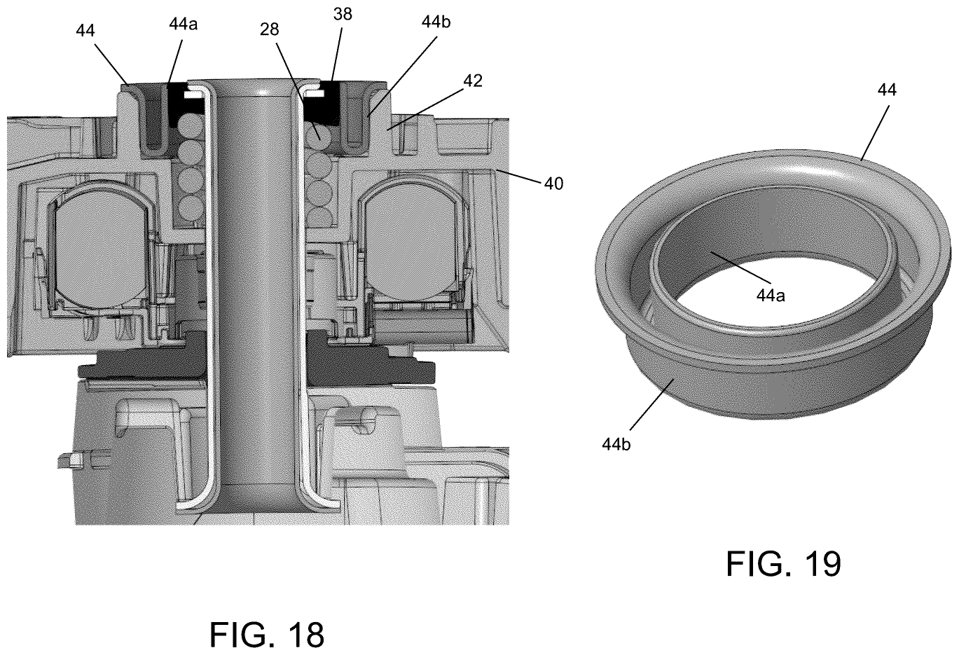

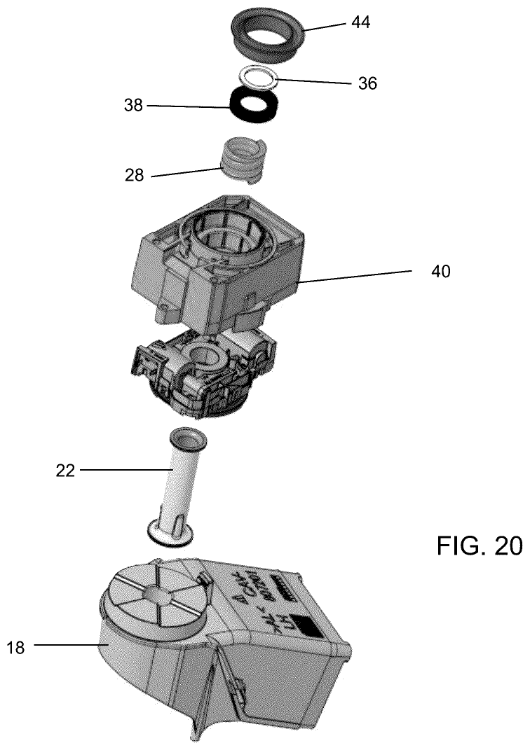

As shown in FIGS. 17-20, to eliminate draft or taper in the interface between the pivot washer 38 and the actuator housing 40 of the mirror assembly, a zero draft insert 44 is pressed into the top side of the actuator housing 40 spring cup area at the top of the pivot tube 22 to constrain the pivot washer 38. The zero draft insert 44 is a deep-draw stamped component with an inner side or surface 44a that engages the pivot washer 38 and has zero or substantially zero draft or taper. That is, the inner surface 44a of the zero draft insert 44 has a constant inner diameter that extends substantially parallel to the cylindrical portion 22a of the pivot post 22. An outer side or surface 44b opposite the inner surface 44a engages the interference ribs 42 of the housing 40 (and the tapered or drafted interference ribs 42 may define a surface that extends at an oblique angle relative to the longitudinal axis of the pivot post 22). The insert 44 may have a substantially U-shaped cross-section so that, when pressed into place, the inner side 44a and the outer side 44b are biased into engagement, respectively, with the pivot washer 38 and interference ribs 42 of the housing 40. Thus, the insert 44 reduces or eliminates shift of the pivot washer 38 along the pivot tube 22 during engagement and disengagement of the detent interfaces.

A deep draw stamping process can produce a cylinder with little to no draft angle within relatively tight tolerances. Eliminating the draft angle where the pivot washer 38 interacts with the mirror head and/or arm bracket of the mirror assembly improves mirror structure, resulting in increased vibration performance and durability. The zero draft insert 44 accomplishes this by adding one single component to the assembly, which is not large or bulky and can be packaged easily. The zero draft insert 44 can be assembled along with the spring 28 and pivot washer 38, and can be pressed into the actuator housing 40 as part of the orbital riveting process.

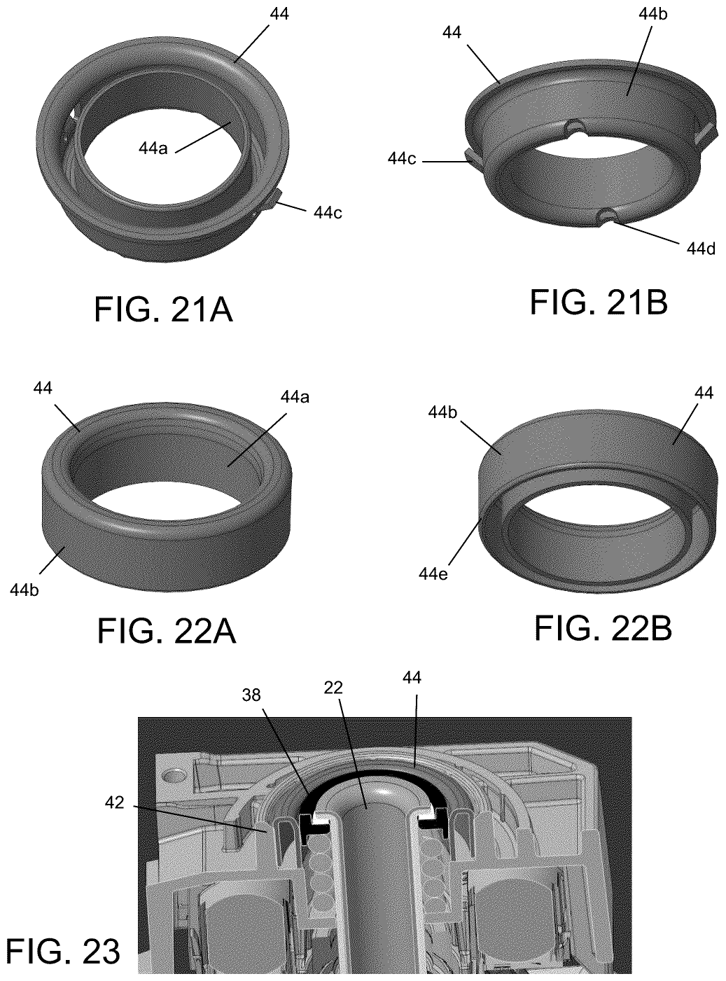

Optionally, the insert 44 may include one or more flexible barbs 44c extending from the outer side 44b (FIG. 21A) and configured to flex when engaged with the interference ribs 42 to improve retention of the insert 44 at the housing 40. Optionally, one or more drainage holes or slots 44d (FIG. 21B) may be formed at the bottom of the U-shaped channel between the inner side 44a and the outer side 44b. Optionally, the insert 44 may be configured to be inverted with a tapered lead-in or edge 44e formed on the outer side 44b (FIGS. 22A and 22B) for easier assembly. That is, the insert 44 may be configured to be installed such that the insert 44 is disposed along the pivot tube 22 between the pivot washer 38 and the interference ribs 42 of the housing 40, with the U-shaped channel between the inner side 44a and the outer side 44b having an opening facing the retainer 26 and the inner and outer sides extending along the pivot tube 22 toward the mounting base 18 (e.g., FIG. 23).

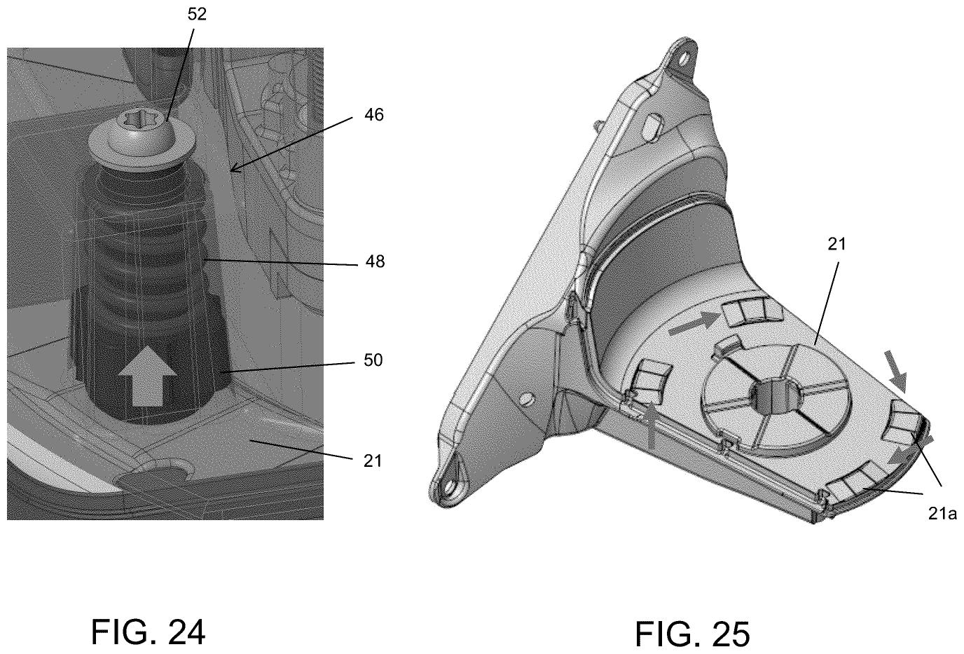

Referring to FIGS. 24 and 25, the mirror assembly includes one or more spring loaded touchpads or contacts or retaining elements 46 that apply a retention force between the mirror head 12 and the base 21 when the mirror head 12 is pivoted to a detent position to improve vibration performance (i.e., reduce movement of the mirror head due to vibrations) as the vehicle travels along the road. The spring loaded touchpad 46 includes a biasing element or coil spring 48 disposed along a contact pad 50 and between a first, base end of the contact pad 50 and an upper end of the contact pad 50. Optionally, the coil spring 48 engages the base end of the contact pad and a lower surface of the actuator or detent assembly. The spring loaded touchpad 46 is pivotally fixed relative to the mirror head via a screw 52 (or other suitable fastener) that extends through the lower surface of the actuator or detent assembly and engages the upper end of the contact pad 50. The contact pad 50 moves with the mirror head and travels along detent surfaces 21a of the base 21 as the mirror head pivots so that, when the mirror head is pivoted to a detent position, the contact pad 50 is disposed at a detent surface 21a and the contact pad 50 is moved vertically toward the mirror head and the actuator assembly to compress the coil spring 48 and apply a retention force to secure the mirror head in the detent position. The mirror assembly may include four (or more or less) spring loaded touchpad assemblies 46 to correspond to four (or more or less) detent surfaces 21a at the base 21.

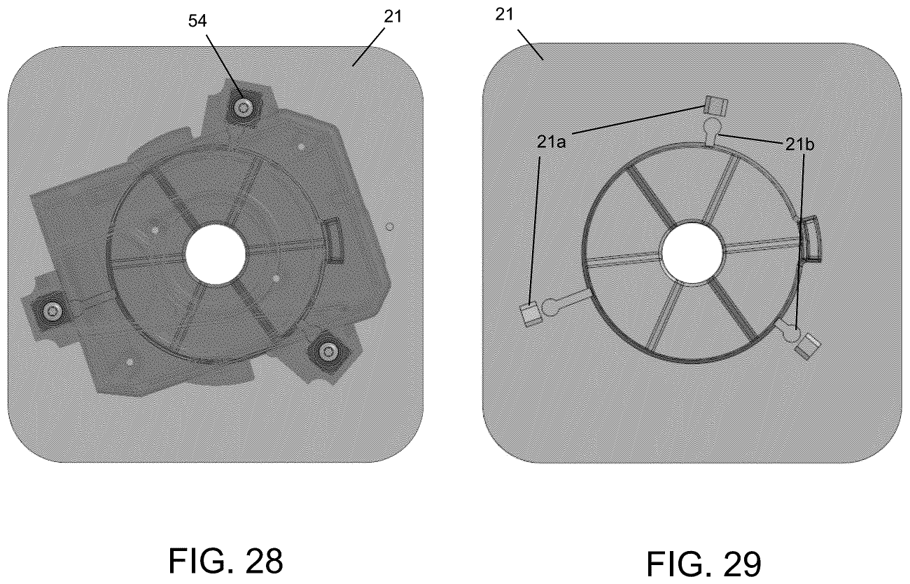

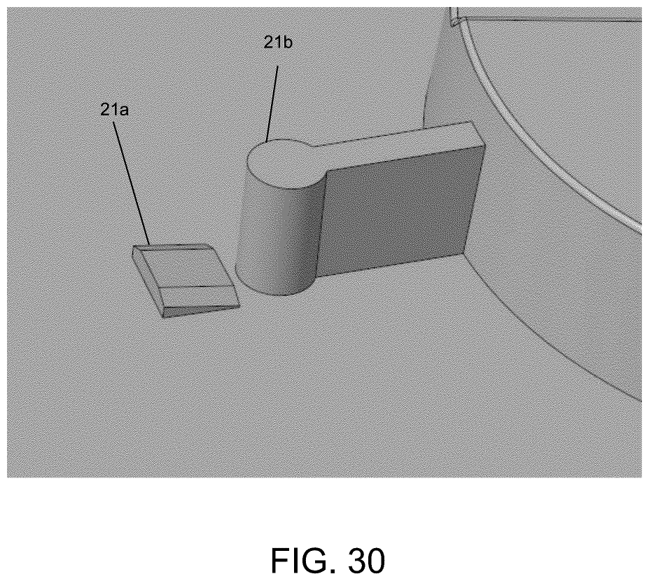

As shown in FIGS. 26-32, instead of a coil spring, a toggle touchpad or radial contact or radial retaining element 54 may include a linkage toggle 56 pivotally coupled to a linkage base 58, with a screw 60 (or other suitable fastener) coupling the toggle touchpad 54 to a lower surface of the actuator or detent assembly. The linkage toggle 56 is connected to the linkage base 58 via a hinged connection.

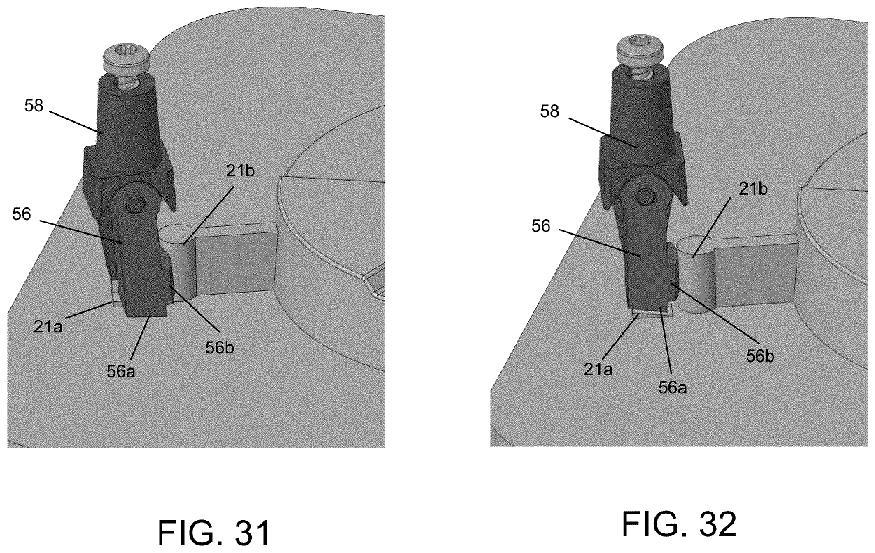

The linkage toggle 56 includes a first base contact surface 56a configured to engage a detent surface or contact pad 21a of the base element 21 and a second base contact surface 56b configured to engage a radially extending toggle bumper 21b of the base element 21. The first base contact surface 56a is disposed at a lower end of the linkage toggle 56 distal from the hinged connection to the linkage base 58 and the second base contact surface 56b is disposed along the toggle 56 between the lower end and the hinged connection. Each toggle bumper 21b is radially aligned with a respective detent surface 21a at the base 21. Thus, when the mirror head moves from a non-detent position (FIG. 31) to a detent position (FIG. 32), the second base contact surface 56b engages the toggle bumper 21b and the linkage toggle 56 pivots relative to the linkage base 58 to move the first base contact surface 21a into engagement with the wedge-shaped detent surface 21a. Thus, the engagement between the linkage toggle 56 and the base 21 effectively wedges the toggle 56 between the bumper 21b and the detent surface 21a to provide the retention force for the mirror head at the detent position.

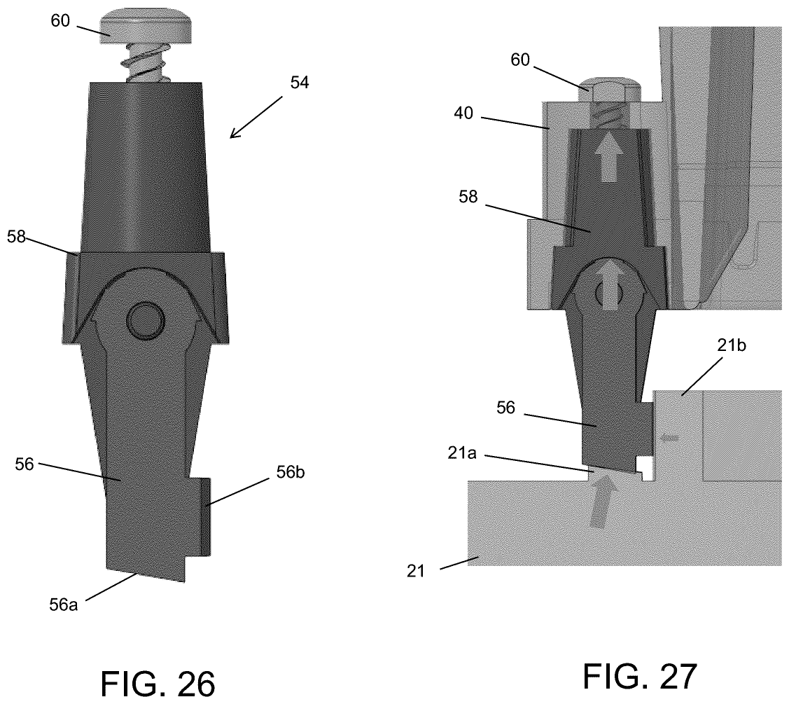

The load from the base 21 to the mirror arm or head travels up from the detent surface 21a on the base 21 into the linkage toggle 56, through a bearing surface between the linkage toggle 56 and the linkage base 58 and then up into the actuator housing 40 (FIG. 27). Thus, the toggle touchpad 54 provides a more rigid toggle link design that improves vibration performance and damping for the mirror assembly. The toggle touchpad can be activated both manually and electrically, and works in both the forward and rearward fold directions. The toggle touchpad includes the same or similar number of parts and requires the same or similar assembly process as the spring loaded touchpad. The mirror assembly may include any suitable number of toggle touchpads, such as three or four or more.

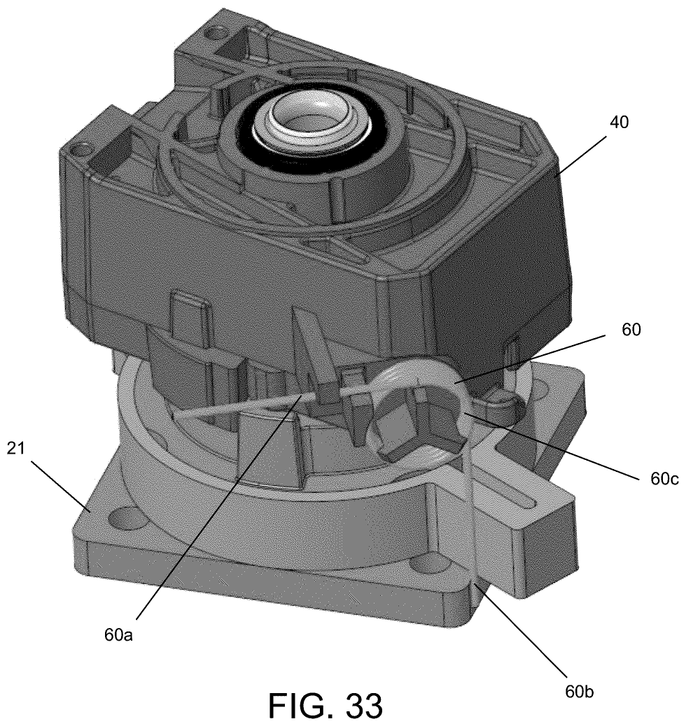

As shown in FIGS. 33-37, the mirror assembly may include a biasing element, such as a torsion spring 60, that is coupled to the actuator housing 40 and that interfaces with or engages the base 21 as the mirror head approaches its park or folded position to apply a resistance torque against the pivoting motion and mechanically slow pivoting of the actuator 20 before the actuator hits a travel stop at the detent position. By mechanically slowing the actuator before it hits the travel stop, the electric life cycle of the powerfold actuator is increased.

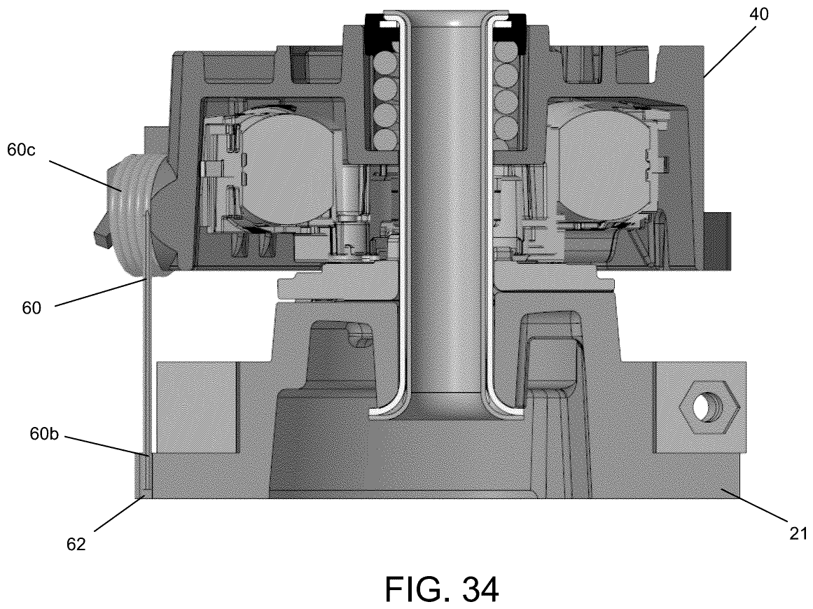

In the illustrated example, the torsion spring 60 includes a first end 60a that is constrained at the housing 40, a second opposite end 60b that is constrained by a notch or engagement feature 62 at the base 21 (FIG. 34), and a winding portion 60c that is disposed at the bracket 40, with the winding 60c disposed between the first end 60a and the second end 60b. Thus, as the mirror head approaches the travel stop, the first end 60a and/or the second end 60b compress the winding 60c and resist movement of the actuator toward the travel stop.

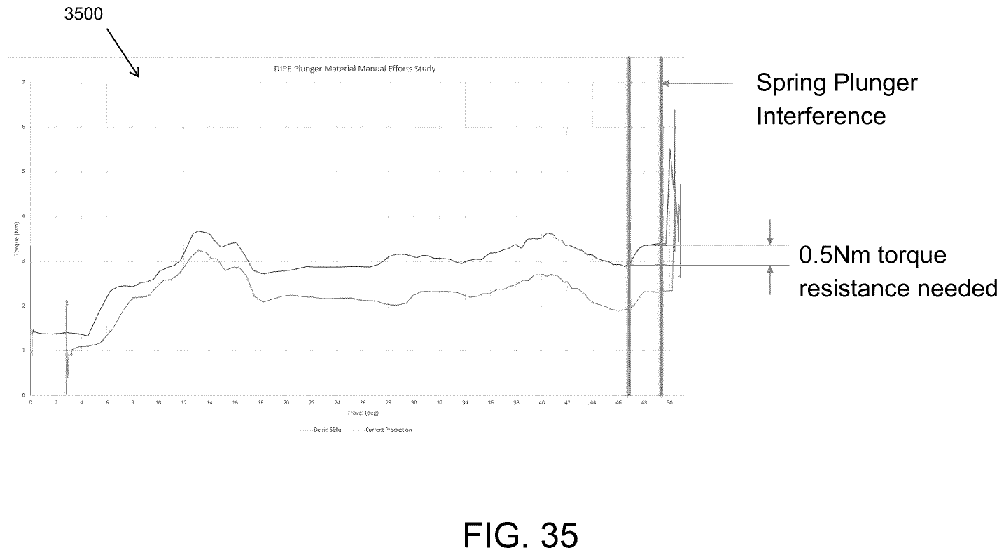

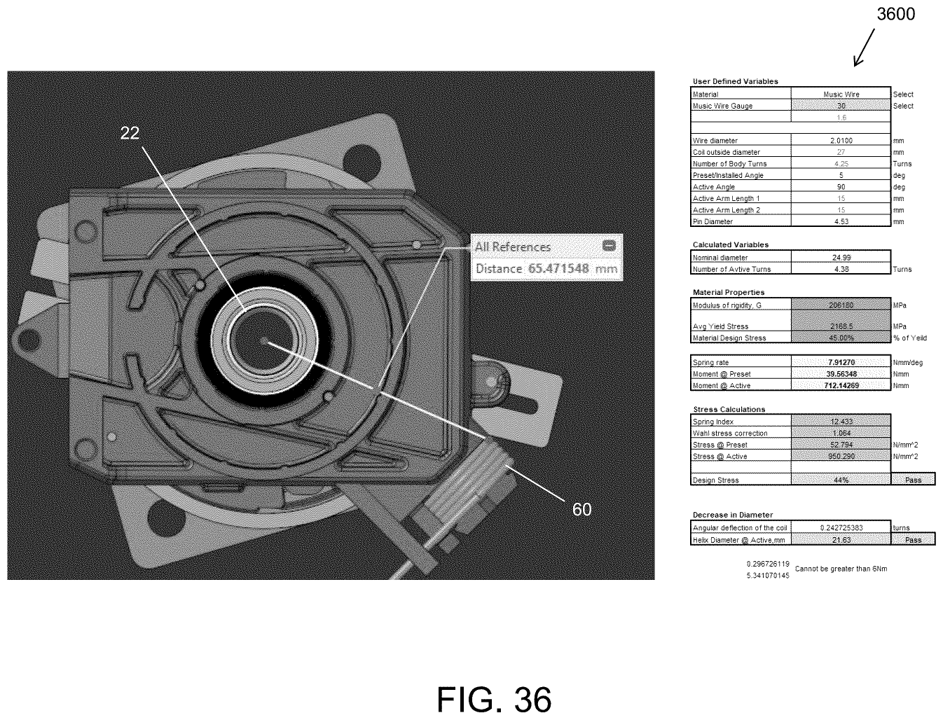

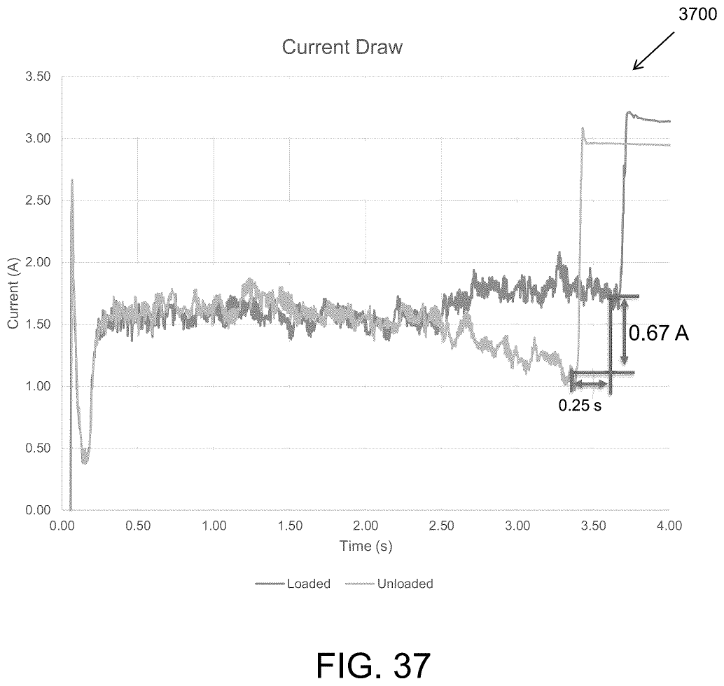

The torsion spring 60 may replicate the slowdown effect of spring plungers at the end of travel, while eliminating spring plungers from the assembly and their negative effects during transit. For example, the diagram 3500 of FIG. 35 shows that typical spring plungers may apply about 0.5 Newton meters of torque resistance as the mirror head approaches a travel stop while pivoting between detent positions. As shown in FIG. 36, the diagram 3600 shows example dimensions and characteristics of the torsion spring 60, where the torque resistance of the torsion spring 60 is determined based on the radial distance of the torsion spring relative to the pivot axis of the mirror head defined by the pivot tube 22. Thus, the decrease in speed and increase in electrical current draw for the actuator dampens the load of the travel stop. For example, as shown by the diagram 3700 of FIG. 37, the torsion spring 60 may cause travel time between detent positions to increase by 0.25 seconds and an increase in current draw for the cycle of 0.67 amps when the torsion spring provides 1.6 Newton meters of torque resistance.

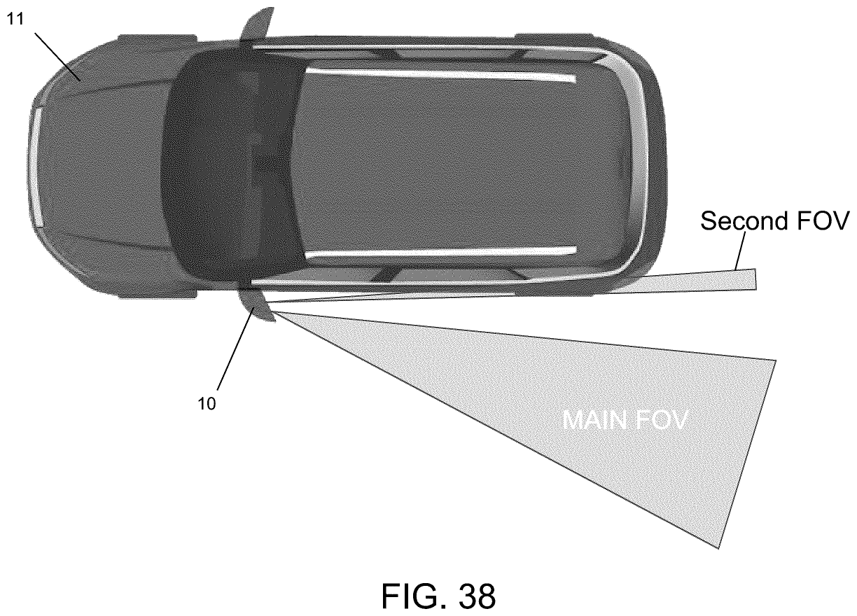

Referring to FIGS. 38-43, the exterior rearview mirror assembly 10 may include an additional mirror or mirror reflective element or mirror plane that is configured to provide a body reference when aiming the mirror reflective element to help the driver properly aim or adjust the mirror assembly for optimal field of view coverage. For example, the mirror reflective element 14 may include a first portion or mirror segment 14a and a second portion or mirror segment 14b, where the first portion 14a provides a first field of view to the driver (i.e., the main field of view) that is rearward and along the side of the vehicle 11 and the second portion 14b provides a different second field of view to the driver that is rearward and along the side of the vehicle 11. The second portion 14b is disposed closer to the side of the vehicle and angled or positioned or bent relative to the first portion 14a of the mirror reflective element 14 so that the second field of view is further inboard or inward toward and along the side of the vehicle 11 than the first field of view. For example, with the mirror head in the use position, an angle between the plane of the second portion 14b and the side of the vehicle may be less than angle between the plane of the first portion 14a and the side of the vehicle. The mirror reflective element 14 is configured so that the first field of view provides the main field of view rearward and along the side of the vehicle (e.g., to view vehicles and objects in a blind spot of the vehicle that is rearward and along the side of the vehicle) and the second field of view assists the driver, when adjusting the mirror reflective element relative to the vehicle, in positioning the mirror reflective element to optimize the first field of view.

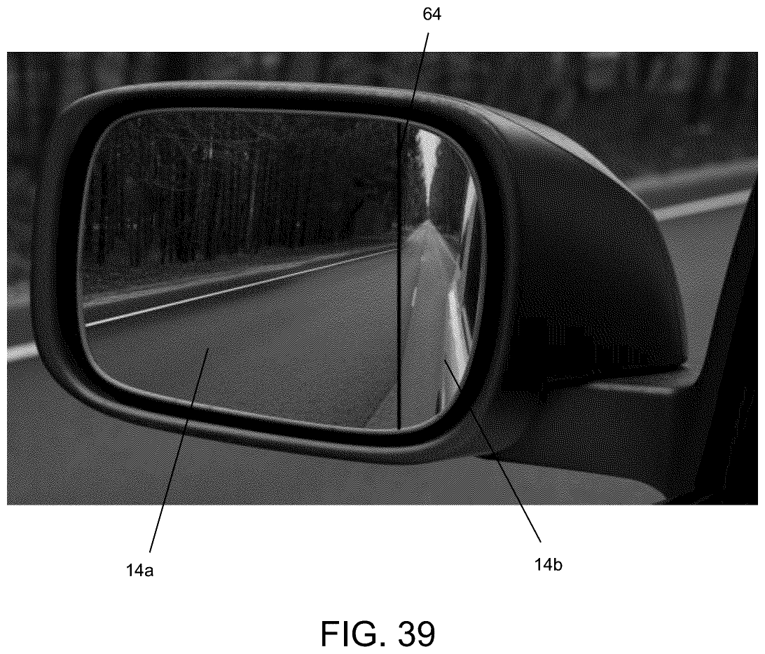

As shown in FIG. 39, when the mirror reflective element 14 is properly positioned or angled relative to the side of the vehicle 11, the first portion 14a provides the main field of view and the second portion 14b provides a body reference field of view. When adjusting the mirror reflective element 14, the driver positions the mirror reflective element so that a portion of the side of the vehicle is visible at the second portion 14b of the mirror reflective element 14. For example, when the mirror reflective element 14 is properly positioned, the driver may be able to view a portion of the side of the vehicle and a portion of the road at the second portion 14b of the mirror reflective element 14 (FIG. 39). When the side of the vehicle 11 is partially visible at the second portion 14b (FIG. 39), the main field of view is optimized to, for example, include a blind spot of the driver.

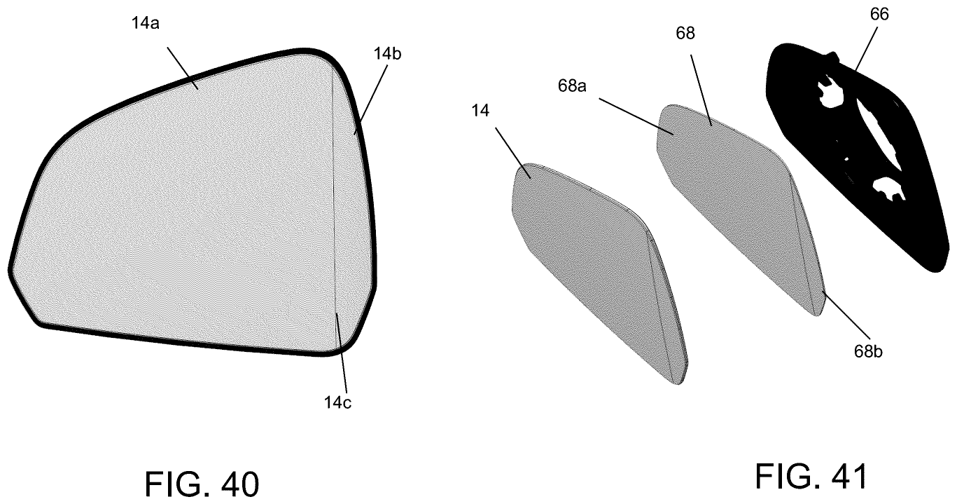

The mirror reflective element 14 may comprise a singular mirror reflective element with a bend point 14c disposed between the first portion 14a and the second portion 14b (FIGS. 40 and 41). That is, the first portion 14a may define a first plane of the mirror reflective element 14 and the second portion 14b may define a second plane of the mirror reflective element, with the first plane angled relative to the second plane at the bend point 14c to differentiate the first and second fields of view. Thus, the first portion 14a and the second portion 14b may comprise portions of a continuous or singular mirror reflective element, and a trim piece or seal or demarcation 64 may be disposed at an outer surface of the mirror reflective element and along the bend point 14c to hide or cover the curved portion of the mirror reflective element at the bend point between the first and second planes of the first and second portions.

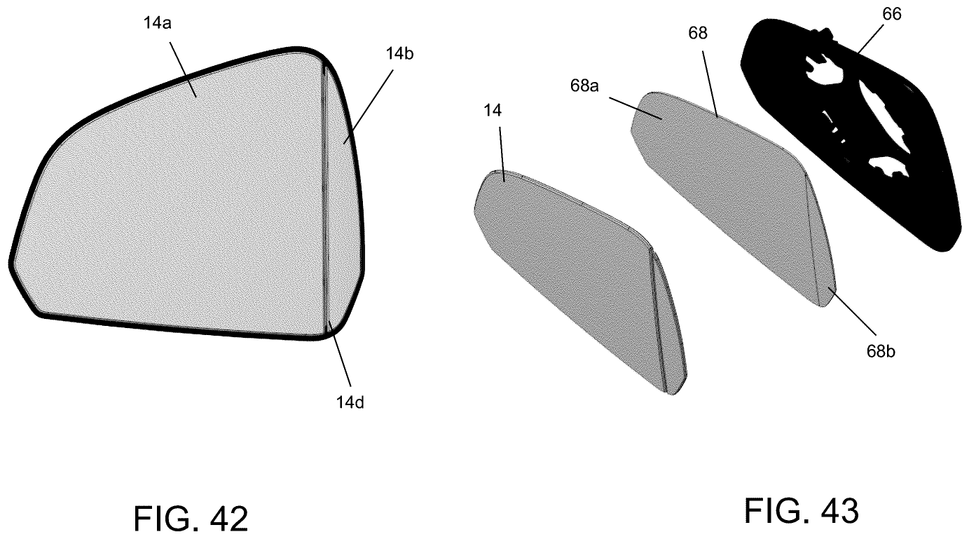

Optionally, the first portion 14a and the second portion 14b may comprise separate, planar portions of the mirror reflective element 14 that are angled relative to one another (FIGS. 42 and 43). That is, rather than bending the mirror reflective element to provide the first and second portions, the mirror reflective element may include separate first and second portions that are angled relative to one another (with both portions being movable together and in tandem with one another when the driver adjusts the rearward view). The first portion 14a and the second portion 14b may be separated from one another via a gap 14d in the mirror reflective element, or the first and second portions may be directly adjacent one another. The seal or trim piece 64 may be disposed along the gap 14d (or at the seam between the first and second portions) to protect and cover the edges of the mirror reflective element.

The mirror reflective element 14 may be attached at the mirror head 12 via an attachment plate or backplate or mounting element 66, and a heater pad 68 may be disposed between the backplate 66 and the mirror reflective element 14. The backplate 66 may include a bend or angle to accommodate the angle between the first and second portions of the mirror reflective element. Optionally, the mirror assembly may include first and second backplates corresponding, respectively, to the first and second portions of the mirror reflective element 14 to separately attach the first and second portions to the mirror casing. Optionally, for mirror assemblies where the mirror head and the reflective element moves together and in tandem with one another when the driver adjusts the rearward view (such as by utilizing aspects of the mirror assemblies described in U.S. Publication Nos. US-2021-0331625; US-2021-0213880; US-2020-0353867 and/or US-2020-0223364, and/or U.S. Pat. Nos. 11,325,535; 10,099,618; 9,827,913; 9,346,403 and/or 8,915,601, which are all hereby incorporated herein by reference in their entireties), the second portion 14b may be disposed anywhere at the mirror head, such as at a side portion of the mirror head facing the vehicle, with the second portion angled so that the driver views rearward along the side of the vehicle when the first portion is at a position that provides an appropriate rearward view to the driver.

Similarly, the heater pad 68 may include a first portion 68a that couples to the first portion 14a of the mirror reflective element and a second portion 68b that couples to the second portion 14b of the mirror reflective element. The first portion 68a may be bent or separate from the second portion 68b to accommodate the angle between the first and second portions of the mirror reflective element 14. The first and second portions of the heater pad 68 may be separably or selectively operable to selectively heat or defrost the first and second portions of the mirror reflective element 14.

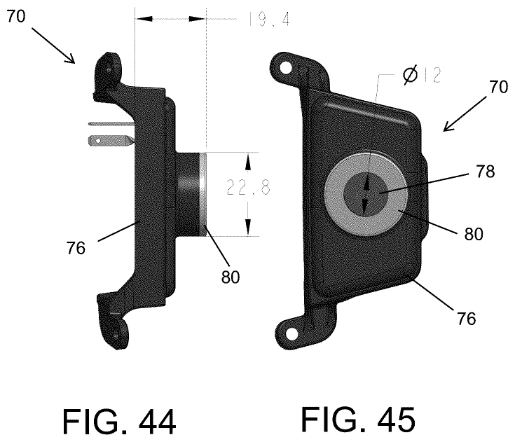

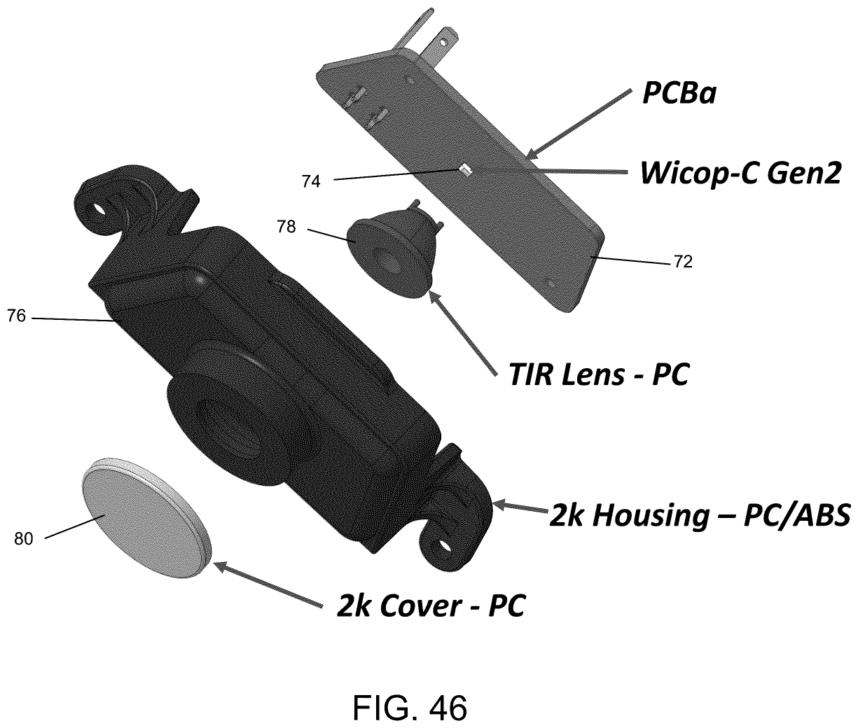

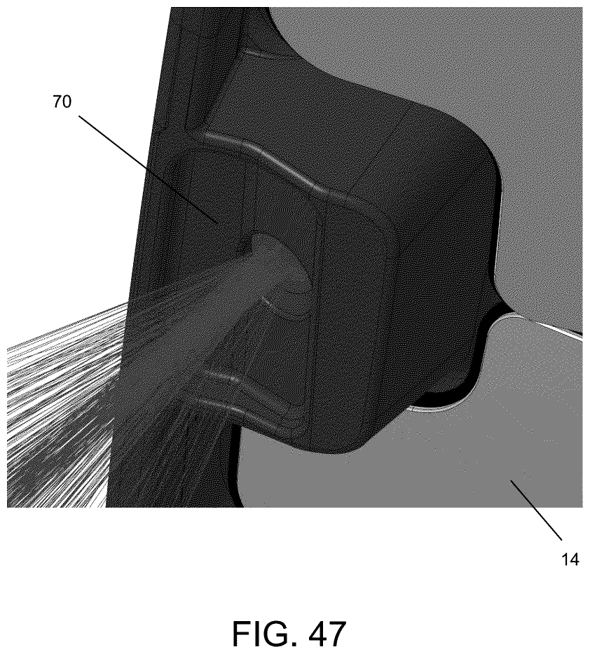

Referring to FIGS. 44-50, a light module 70 may be disposed at the exterior rearview mirror assembly and configured to, when electrically operated to emit light, direct light rearward and along the side of the vehicle. The light module 70 may be disposed behind the mirror reflective element 14 and configured to emit light that is visible through the mirror reflective element 14, or the light module 70 may be disposed remote from the mirror reflective element (e.g., disposed adjacent to the mirror reflective element) and at the mirror head (FIG. 47). The light module 70 may be selectively activated in response to a user input. For example, the light module 70 may operate as a reverse light indicator that emits light in response to the user selecting a reverse gear at a gear selector of the vehicle, and the emitted light is visible to other vehicles and persons exterior the equipped vehicle to inform them that the equipped vehicle is travelling or about to travel in a rearward direction. Optionally, the light module 70 may operate as a turn signal indicator or a blind spot zone indicator.

The light module 70 includes a light printed circuit board (light PCB) 72 having a first side and a second side opposite the first side and separated from the first side by a thickness of the light PCB 72. A light source 74, such as a light emitting diode (LED) or micro-LED, is disposed on the first side of the light PCB 72. The light PCB 72 is accommodated by a housing 76 of the light module 70, with a total internal reflection lens (TIR lens) 78 accommodated by the housing 76 and disposed in front of the light source 74 so that the light source 74 emits light through the TIR lens 78. The TIR lens 78 may be disposed at an aperture in the housing 76 and a cover or secondary lens 80 may be disposed over the aperture to protect the TIR lens 78 and electronics from contaminants and moisture. An electrical connector may be disposed at the light PCB (e.g., the second side of the light PCB) for electrical connection to a wire harness of the vehicle. The light module 70 may attach at the mirror head via one or more fasteners extending through one or more corresponding through holes formed in the housing 76.

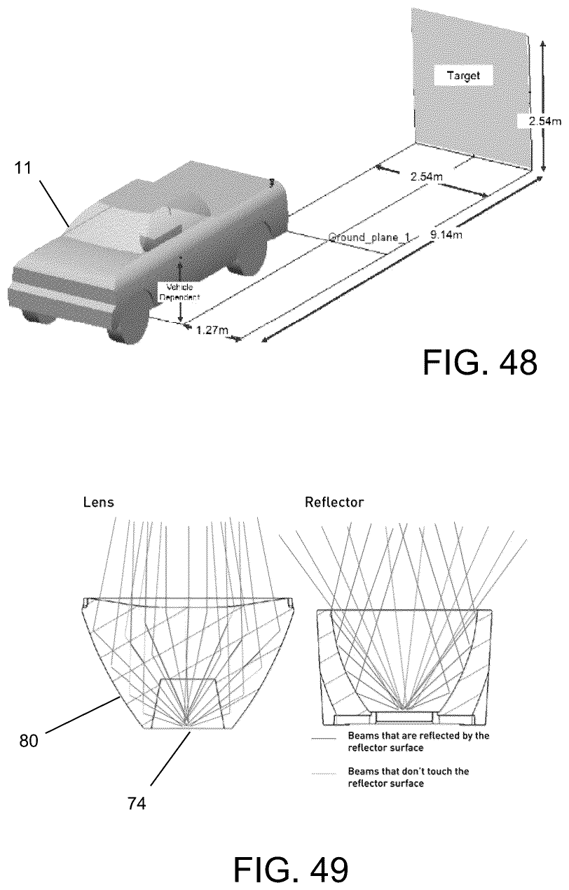

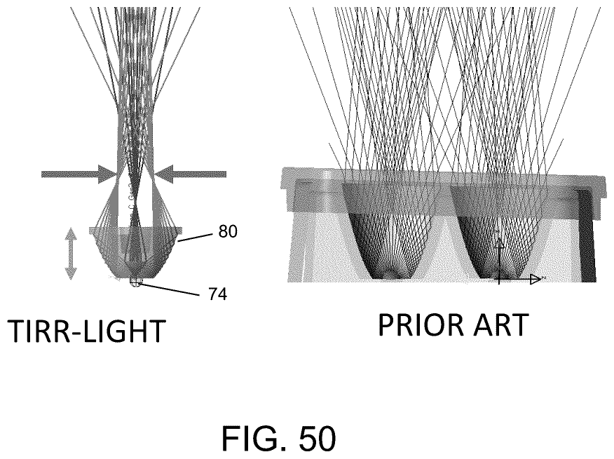

FIGS. 48-50 depict differences in light propagation from the TIR lens 78 as compared to a traditional reflector. For example, to provide the illumination needed for light emitted from the light module to be visible at a minimum distance rearward of the vehicle 11 (e.g., 9.14 meters, such as shown in FIG. 48), a traditional reflector may include two or more LEDs that each provide 124 lumens at 350 milliamps (FIG. 50). In comparison, the light module 70 with TIR lens 80 may provide the required illumination using a single LED that provides 212 lumens at 500 milliamps (FIG. 50). The light module 70 may utilize any suitable LED, such as those commercially available from Seoul Semiconductor Co. Ltd. of Ansan-si, South Korea.

The TIR lens 80 may be shorter or more compact than typical reflectors (FIG. 50) and condenses generated light into a narrow cone before the light leaves the mirror's Class-A surface (i.e., outermost surface), whereas a typical reflector allows light beams to exit the reflector in a wide cone without reflecting off an internal surface (FIG. 49). Thus, the light module 70 including the TIR lens 78 provides increased control of emitted light rays, higher energy efficiency, and reduces the light cone as much as possible. The smaller aperture in the housing used with the TIR lens 78 provides better styling.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Optionally, the exterior mirror element of a mirror assembly may include heater pad or film or element at a rear surface of the mirror reflective element. The heater pad or element at the rear surface of the glass substrate may comprise a mirror defrost/demisting heater and may provide an anti-fogging of de-fogging feature to the exterior mirror assembly, and may utilize aspects of the heater elements or pads described in U.S. Pat. Nos. 9,481,304; 8,058,977; 7,400,435; 5,808,777; 5,610,756 and/or 5,446,576, and/or U.S. Pat. Publication No. 20080011733; which are hereby incorporated herein by reference in their entireties. The heater element may include electrical contacts that extend rearward therefrom and through an aperture of attaching portion of back plate for electrical connection to a wire harness or connector of the mirror assembly, or the back plate and/or heater pad may include suitable electrical connectors and connections incorporated therein (such as by utilizing aspects of the mirror assembly described in U.S. Pat. No. 7,400,435, which is hereby incorporated herein by reference in its entirety) for electrically connecting the heater pad (or other suitable electrical connectors may be utilized, such as electrical leads or wire harnesses or pigtails or other separate connectors or cables or the like). Optionally, the heater pad may comprise a screen printed heater pad. For example, the heater pad can be printed on the back of the mirror reflective element (such as at the fourth or rear surface of the rear substrate). Such coatings may be printed and then cured at around 120 degrees C. or lower, making this process compatible with already formed laminate type EC mirror elements, such as those described in U.S. Pat. No. 5,724,187, which is hereby incorporated herein by reference in its entirety. This would make it compatible with EC mirrors.

Optionally, the mirror assembly may include a blind spot indicator and/or a turn signal indicator, such as an indicator or indicators of the types described in U.S. Pat. Nos. 8,242,896; 7,492,281; 6,198,409; 5,929,786; and 5,786,772, which are hereby incorporated herein by reference in their entireties. The signal indicator or indication module may include or utilize aspects of various light modules or systems or devices, such as the types described in U.S. Pat. Nos. 8,764,256; 7,626,749; 7,581,859; 6,227,689; 6,582,109; 5,371,659; 5,497,306; 5,669,699; 5,823,654; 6,176,602 and/or 6,276,821, and/or U.S. Publication No. US-2013-0242586, which are all hereby incorporated herein by reference in their entireties.

Such an indicator or indicators may function as a lane change assist (LCA) indicator or indicators and/or a blind spot indicator or indicators. Such blind spot indicators are typically activated when an object is detected (via a side object or blind spot detection system or the like such as described in U.S. Pat. Nos. 7,492,281; 7,038,577; 6,882,287; 6,198,409; 5,929,786; 5,786,772 and/or 7,720,580, which are hereby incorporated herein by reference in their entireties) at the side and/or rear of the vehicle (at the blind spot) and when the turn signal is also activated, so as to provide an alert to the driver of the host vehicle that there is an object or vehicle in the lane next to the host vehicle at a time when the driver of the host vehicle intends to move over into the adjacent lane. Optionally, and alternately, the indicator or indicators may function as a lane change assist indicator or indicators, where the host vehicle may be detected to be moving into an adjacent lane without the turn signal being activated, and an object or vehicle may be detected at the adjacent lane, whereby the LCA indicator or indicators may be activated to provide an alert to the driver of the lane change to assist the driver in avoiding unintentional lane changes and/or lane changes when a vehicle or object is detected in the adjacent lane.

The blind spot indicators thus may be operable to provide an indication to the driver of the host vehicle that an object or other vehicle has been detected in the lane or area adjacent to the side of the host vehicle. The blind spot indicator may be operable in association with a blind spot detection system, which may include an imaging sensor or sensors, or an ultrasonic sensor or sensors, or a sonar sensor or sensors or the like. For example, the blind spot detection system may utilize aspects of the blind spot detection and/or imaging systems described in U.S. Pat. Nos. 7,038,577; 6,882,287; 6,198,409; 5,929,786; 5,786,772; 7,881,496 and/or 7,720,580, and/or of the reverse or backup aid systems, such as the rearwardly directed vehicle vision systems described in U.S. Pat. Nos. 5,550,677; 5,760,962; 5,670,935; 6,201,642; 6,396,397; 6,498,620; 6,717,610 6,757,109 and/or 7,005,974, and/or of the automatic headlamp controls described in U.S. Pat. Nos. 5,796,094; 5,715,093; and/or 7,526,103, and/or of the rain sensors described in U.S. Pat. Nos. 6,250,148 and 6,341,523, and/or of other imaging systems, such as the types described in U.S. Pat. Nos. 6,353,392 and 6,313,454, which may utilize various imaging sensors or imaging array sensors or cameras or the like, such as a CMOS imaging array sensor, a CCD sensor or other sensors or the like, such as the types disclosed in commonly assigned, U.S. Pat. Nos. 8,982,273; 6,097,023; 5,796,094; 5,760,962 and/or 5,550,677, with all of the above referenced U.S. patents, patent applications and provisional applications and PCT applications being commonly assigned and being hereby incorporated herein by reference in their entireties.

The reflective element of the rearview mirror assembly of vehicles may include an auxiliary wide angle or spotter mirror portion, such as the types described in U.S. Pat. Nos. 7,255,451; 7,195,381; 6,717,712; 7,126,456; 6,315,419; 7,097,312; 6,522,451; 6,315,419; 5,080,492; 5,050,977 and/or 5,033,835, which are hereby incorporated herein by reference in their entireties, and optionally may have an integrally formed auxiliary mirror reflector, such as the types described in U.S. Pat. Nos. 8,736,940 and 7,748,856, which are hereby incorporated herein by reference in their entireties. The auxiliary wide angle optic may be integrally formed such as by physically removing, such as by grinding or ablation or the like, a portion of the second surface of the front substrate so as to create or establish a physical dish-shaped generally convex-shaped depression or recess or crater at the second surface of the front substrate, and coating the formed depression or recess with a reflector coating or element or the like, such as described in U.S. Pat. No. 8,021,005, incorporated above. The mirror reflective element includes a demarcating layer or band or element that is disposed or established around the perimeter of the reflective element and around the perimeter of the spotter mirror so as to demarcate the spotter mirror from the main reflector portion to enhance the viewability and discernibility of the spotter mirror to the driver of the vehicle, such as by utilizing aspects of the hiding layers described in U.S. Pat. No. 8,736,940, which is hereby incorporated herein by reference in its entirety. The demarcating layer or contrasting coating or layer or material may comprise any suitable material, and may provide a different color or reflectivity or may comprise a dark or opaque color to demarcate the spotter mirror and enhance discernibility of the spotter mirror from the main mirror, which may comprise a flat mirror, a convex mirror or a free form mirror (such as utilizing aspects of the mirrors described in U.S. Pat. No. 8,917,437, which is hereby incorporated herein by reference in its entirety).

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mirror head accommodating a mirror reflective element;
a mounting base configured for mounting the vehicular exterior rearview mirror assembly at a side of a vehicle equipped with the vehicular exterior rearview mirror assembly;
wherein, with the vehicular exterior rearview mirror assembly mounted at the side of the vehicle, the mirror head is movable relative to the mounting base between at least (i) an extended position, where the mirror head is extended outward from the side of the vehicle so that the mirror reflective element is positioned to provide a rearward view at the side of the vehicle to a driver of the vehicle, and (ii) a folded position, where the mirror head is folded inward from the extended position toward the side of the vehicle;
an electrically operable actuator, wherein, with the vehicular exterior rearview mirror assembly mounted at the side of the vehicle, the actuator is electrically operable to move the mirror head relative to the mounting base between the folded position and the extended position;
a pivot tube that extends from the mounting base and through a base portion of the actuator, and wherein, when the mirror head is moved between the extended position and the folded position, the mirror head moves about a longitudinal axis of the pivot tube;
wherein the pivot tube comprises a tapered portion at least partially received at a channel of the mounting base, and wherein an inner surface of the channel comprises a shape that corresponds to a shape of an outer surface of the tapered portion of the pivot tube; and
wherein the actuator comprises a biasing element disposed between a housing of the actuator and an upper end of the pivot tube, and wherein the biasing element biases the tapered portion of the pivot tube toward engagement with the inner surface of the mounting base along the channel.

2. The vehicular exterior rearview mirror assembly of claim 1, wherein the pivot tube comprises a radially extending flange disposed at a lower end of the pivot tube opposite the upper end of the pivot tube, and wherein the flange, with the tapered portion of the pivot tube biased toward engagement with the inner surface of the mounting base along the channel, is spaced from the mounting base.

3. The vehicular exterior rearview mirror assembly of claim 1, wherein the longitudinal axis of the pivot tube, with the tapered portion of the pivot tube biased toward engagement with the inner surface of the mounting base along the channel, is coaxial with a longitudinal axis of the channel.

4. The vehicular exterior rearview mirror assembly of claim 1, wherein the outer surface of the tapered portion of the pivot tube comprises (i) a first portion having a first diameter and (ii) a second portion having a second diameter, and wherein the second portion is closer along the longitudinal axis of the pivot tube to the upper end of the pivot tube than the first portion, and wherein the first diameter is greater than the second diameter.

5. The vehicular exterior rearview mirror assembly of claim 1, wherein a pivot washer is disposed between the upper end of the pivot tube and the biasing element.

6. The vehicular exterior rearview mirror assembly of claim 5, wherein the pivot washer comprises (i) a first radial portion that engages the biasing element and (ii) a second radial portion that is axially offset from the first radial portion along the longitudinal axis of the pivot tube and that extends radially from the pivot tube and along the housing of the actuator.

7. The vehicular exterior rearview mirror assembly of claim 6, wherein the mirror head comprises a bracket that attaches at the housing of the actuator, and wherein the second radial portion of the pivot washer extends along the housing of the actuator between the housing of the actuator and the bracket.

8. The vehicular exterior rearview mirror assembly of claim 7, wherein the bracket includes a flange portion that extends along the pivot tube between the upper end of the pivot tube and the first radial portion of the pivot washer.

9. The vehicular exterior rearview mirror assembly of claim 5, wherein the pivot washer circumscribes the upper end of the pivot tube, and wherein the pivot washer is disposed radially between the pivot tube and an interference rib of the housing, and wherein a flexible insert is disposed between the interference rib of the housing and the pivot washer to urge the pivot washer radially toward the pivot tube.

10. The vehicular exterior rearview mirror assembly of claim 9, wherein the flexible insert comprises (i) a first surface that engages a surface of the interference rib and (ii) a second surface that engages an outer surface of the pivot washer, and wherein the surface of the interference rib extends at an oblique angle relative to the longitudinal axis of the pivot tube, and wherein the second surface of the flexible insert and the outer surface of the pivot washer respectively extend parallel to the longitudinal axis of the pivot tube.

11. The vehicular exterior rearview mirror assembly of claim 1, wherein the pivot tube extends at least partially through a detent assembly of the actuator.

12. The vehicular exterior rearview mirror assembly of claim 11, wherein the biasing element releasably retains the actuator in at least one detent state of the actuator.

13. The vehicular exterior rearview mirror assembly of claim 12, wherein the actuator comprises a retaining element that, when the actuator is in at least one detent state of the actuator, engages a detent surface of the base portion, and wherein, when the retaining element engages the detent surface of the base portion, the retaining element is moved toward a retaining position that releasably retains the actuator in the at least one detent state.

14. The vehicular exterior rearview mirror assembly of claim 13, wherein the retaining element comprises (i) a first portion that is fixed relative to the actuator housing, and (ii) a second portion that pivots relative to the first portion of the retaining element, and wherein, when the actuator is in the at least one detent state, the second portion of the retaining element engages a radially extending detent of the base portion and the second portion of the retaining element is pivoted into engagement with the detent surface of the base portion.

15. The vehicular exterior rearview mirror assembly of claim 14, wherein the second portion of the retaining element is biased radially toward engagement with the radially extending detent of the base portion.

16. The vehicular exterior rearview mirror assembly of claim 13, wherein the retaining element comprises a plurality of retaining elements, and wherein each retaining element of the plurality of retaining elements, when the actuator is in the at least one detent state, engages a respective detent surface of the base portion.

17. The vehicular exterior rearview mirror assembly of claim 1, wherein the mirror head is attached at the housing of the actuator, and wherein the mirror head and the housing of the actuator, when the actuator is electrically operated, move together and in tandem about the longitudinal axis of the pivot tube of the actuator.

18. The vehicular exterior rearview mirror assembly of claim 1, comprising a light module that has a light emitter and a total internal reflection lens, wherein, when electrically operated to emit light, the light emitter emits light that passes through the total internal reflection lens.

19. The vehicular exterior rearview mirror assembly of claim 18, wherein the light module is disposed at the mirror head, and wherein, with the vehicular exterior rearview mirror assembly mounted at the side of the vehicle, the light emitter, when electrically operated to emit light, emits light that passes through the mirror reflective element.

20. The vehicular exterior rearview mirror assembly of claim 1, wherein, with the vehicular exterior rearview mirror assembly mounted at the side of the vehicle, the mirror reflective element comprises (i) a first portion that provides a first rearward view to the driver of the vehicle and (ii) a second portion that is disposed at an angle relative to the first portion and provides a second rearward view to the driver of the vehicle that is different from the first rearward view.

21. A vehicular exterior rearview mirror assembly, the vehicular exterior rearview mirror assembly comprising:
a mirror head accommodating a mirror reflective element;
a mounting base configured for mounting the vehicular exterior rearview mirror assembly at a side of a vehicle equipped with the vehicular exterior rearview mirror assembly;
wherein, with the vehicular exterior rearview mirror assembly mounted at the side of the vehicle, the mirror head is movable relative to the mounting base between at least (i) an extended position, where the mirror head is extended outward from the side of the vehicle so that the mirror reflective element is positioned to provide a rearward view at the side of the vehicle to a driver of the vehicle, and (ii) a folded position, where the mirror head is folded inward from the extended position toward the side of the vehicle;
an electrically operable actuator, wherein, with the vehicular exterior rearview mirror assembly mounted at the side of the vehicle, the actuator is electrically operable to move the mirror head relative to the mounting base between the folded position and the extended position;
a pivot tube that extends from the mounting base and through a base portion of the actuator;
wherein the pivot tube extends at least partially through a detent assembly of the actuator and a housing of the actuator, and wherein the biasing element releasably retains the actuator in at least one detent state of the actuator;
wherein the mirror head is attached at the housing of the actuator, and wherein the mirror head and the housing of the actuator, when the actuator is electrically operated, move together and in tandem about a longitudinal axis of the pivot tube of the actuator;
wherein the pivot tube comprises a tapered portion at least partially received at a channel of the mounting base, and wherein an inner surface of the channel comprises a shape that corresponds to a shape of an outer surface of the tapered portion of the pivot tube; and
wherein the actuator comprises a biasing element disposed between the housing of the actuator and an upper end of the pivot tube, and wherein the biasing element biases the tapered portion of the pivot tube toward engagement with the inner surface of the mounting base along the channel.

22. The vehicular exterior rearview mirror assembly of claim 21, wherein a pivot washer is disposed between the upper end of the pivot tube and the biasing element, and wherein the pivot washer circumscribes the upper end of the pivot tube, and wherein the pivot washer is disposed radially between the pivot tube and an interference rib of the housing, and wherein a flexible insert is disposed between the interference rib of the housing and the pivot washer to urge the pivot washer radially toward the pivot tube.

23. The vehicular exterior rearview mirror assembly of claim 22, wherein the flexible insert comprises (i) a first surface that engages a surface of the interference rib and (ii) a second surface that engages an outer surface of the pivot washer, and wherein the surface of the interference rib extends at an oblique angle relative to the longitudinal axis of the pivot tube, and wherein the second surface of the flexible insert and the outer surface of the pivot washer respectively extend parallel to the longitudinal axis of the pivot tube.

24. The vehicular exterior rearview mirror assembly of claim 21, wherein the actuator comprises a retaining element that, when the actuator is in at least one detent state of the actuator, engages a detent surface of the base portion, and wherein, when the retaining element engages the detent surface of the base portion, the retaining element is moved toward a retaining position that releasably retains the actuator in the at least one detent state.

25. A vehicular exterior rearview mirror assembly, the vehicular exterior rearview mirror assembly comprising:
a mirror head accommodating a mirror reflective element;
a mounting base configured for mounting the vehicular exterior rearview mirror assembly at a side of a vehicle equipped with the vehicular exterior rearview mirror assembly;
wherein, with the vehicular exterior rearview mirror assembly mounted at the side of the vehicle, the mirror head is movable relative to the mounting base between at least (i) an extended position, where the mirror head is extended outward from the side of the vehicle so that the mirror reflective element is positioned to provide a rearward view at the side of the vehicle to a driver of the vehicle, and (ii) a folded position, where the mirror head is folded inward from the extended position toward the side of the vehicle;
an electrically operable actuator, wherein, with the vehicular exterior rearview mirror assembly mounted at the side of the vehicle, the actuator is electrically operable to move the mirror head relative to the mounting base between the folded position and the extended position;
a pivot tube that extends from the mounting base and through a base portion of the actuator, and wherein, when the mirror head is moved between the extended position and the folded position, the mirror head moves about a longitudinal axis of the pivot tube;
wherein the pivot tube extends at least partially through a detent assembly of the actuator, and wherein the biasing element releasably retains the actuator in at least one detent state of the actuator;
wherein the pivot tube comprises a tapered portion at least partially received at a channel of the mounting base, and wherein an inner surface of the channel comprises a shape that corresponds to a shape of an outer surface of the tapered portion of the pivot tube;
wherein the actuator comprises a biasing element disposed between a housing of the actuator and an upper end of the pivot tube, and wherein the biasing element biases the tapered portion of the pivot tube toward engagement with the inner surface of the mounting base along the channel; and
wherein the pivot tube comprises a radially extending flange disposed at a lower end of the pivot tube opposite the upper end of the pivot tube, and wherein the flange, with the tapered portion of the pivot tube biased toward engagement with the inner surface of the mounting base along the channel, is spaced from the mounting base.

26. The vehicular exterior rearview mirror assembly of claim 25, wherein the actuator comprises a retaining element that, when the actuator is in at least one detent state of the actuator, engages a detent surface of the base portion, and wherein, when the retaining element engages the detent surface of the base portion, the retaining element is moved toward a retaining position that releasably retains the actuator in the at least one detent state.

27. The vehicular exterior rearview mirror assembly of claim 25, comprising a light module that has a light emitter and a total internal reflection lens, wherein, when electrically operated to emit light, the light emitter emits light that passes through the total internal reflection lens.

28. The vehicular exterior rearview mirror assembly of claim 27, wherein the light module is disposed at the mirror head, and wherein, with the vehicular exterior rearview mirror assembly mounted at the side of the vehicle, the light emitter, when electrically operated to emit light, emits light that passes through the mirror reflective element.

29. The vehicular exterior rearview mirror assembly of claim 25, wherein, with the vehicular exterior rearview mirror assembly mounted at the side of the vehicle, the mirror reflective element comprises (i) a first portion that provides a first rearward view to the driver of the vehicle and (ii) a second portion that is disposed at an angle relative to the first portion and provides a second rearward view to the driver of the vehicle that is different from the first rearward view.
